(19) United States
(12) Patent Application Publication
(10) Pub. No.: US 2008/0241407 A1
(43) Pub. Date: Oct. 2, 2008

(54) Silicone-Containing Hot-Melt Compositions

(76) Inventors: Hsien-Kun Chu, Wethersfield, CT (US); Thomas Fay-Oy Lim, Killingworth, CT (US); Mathias E. Liistro, Plainville, CT (US)

Correspondence Address: HOFFMANN & BARON, LLP, 6900 JERICHO TURNPIKE, SYOSSET, NY, 11791, US

(21) Appl. No.: 11/661,905

(22) PCT Filed: Sep. 1, 2005
(86) PCT No.: PCT/US2005/031207

§ 371 Date: Jan. 18, 2008

Related U.S. Application Data
(60) Provisional application No. 60/606,696, filed on Sep. 2, 2004.

(51) Int. Cl. B05D 3/02; C08G 77/12

(52) U.S. Cl. 427/387; 528/31

(57) ABSTRACT

Moisture curable compositions having hard and soft segments are disclosed. Also disclosed are dual cure compositions capable of both moisture and radiation cure. The present invention provides compositions which have increased tolerances for high temperatures, and compositions which have increased rheological control.

### FIELD OF THE INVENTION

The present invention relates to silicone urea based polymers which contain alkoxysilyl moisture curable groups and behave like a thermoplastic polymer until crosslinking transforms them into a thermoset.

### BACKGROUND OF THE INVENTION

Thermoplastic polymers are a well-known and widely used class of polymers. Thermoplastic polymers allow for trial and error in attempts to form them into desired shapes. If the thermoplastic polymer is incorrectly molded, it can be re-heated and set again. However, thermoplastic polymers have the disadvantage that a thermoplastic polymer set in an intended form may lose its shape when subjected to temperatures sufficient to cause softening or flow. This can be disadvantageous when the thermoplastic polymer has been set in a desired shape.

Among known thermoplastic polymers are hot melt adhesives. These polymers remain solid until they are heated to the appropriate temperature to make them flow. Hot melts typically form adhesive bonds with the substrate to which they are applied once the flowable polymer is cooled again to a solid.

Contrary to thermoplastic polymers, thermoset polymers avoid the difficulties associated with thermoplastic polymers in that once they are crosslinked, they retain their shape. Unfortunately, this ability that allows the thermoset polymer to maintain its shape can also be a disadvantage—once the thermoset polymer is set in a particular form, it cannot be changed, even if that particular form is not the intended or desired form. Thus, the thermoset polymer must bet set in its correct form the first time it is set.

Rheology control of such compositions has also been a concern. For example, compositions formulated to have a high melting range frequently also have a high viscosity, which can make dispensing of the hot melt difficult. Likewise, the use of a higher molecular weight siloxane in preparation of hot melt compositions can lead to a lower content of hard segments, which can result in poor mechanical properties.

Accordingly, there is a need for a crosslinkable composition that behaves like a hot melt initially, but when exposed to conditions of cure, transforms into a crosslinked composition. Such a polymer should be able to maintain a desired shape without fear of loss of physical properties and structural integrity due to temperature fluctuations. It is also desirable that control over rheological aspects of the compositions should be maintained. Additionally, it is desirable that such a composition be curable both by radiation-cure and moisture-cure.

### SUMMARY OF THE INVENTION

### A) Reactive Polymer Compositions

In one aspect of the invention there is provided a curable hot melt composition including a reactive polymer having the structure A(II):

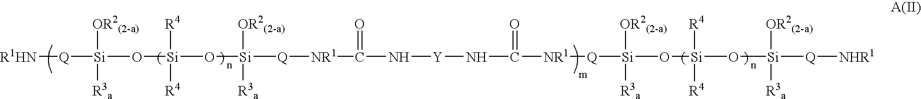

wherein
R¹ in each occurrence may be the same or different and is selected from the group consisting of H and a C₁ to C₁₀ hydrocarbon radical;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical;
Q in each occurrence may be the same or different and is a C₁ to C₁₀ hydrocarbon diradical;
Y in each occurrence may be the same or different and is a C₁ to C₂₀ hydrocarbon diradical;
n in each occurrence may be the same or different and is 1 to about 1,200;
m is 1 to about 100; and
a in each occurrence may be the same or different and is 0 or 1.

In another aspect of the invention there is provided a curable hot melt composition, including the reaction product of a diisocyanate and a siloxane, wherein the structure A(I):

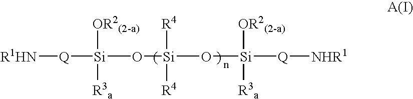

wherein R¹, R², R³, R⁴, n, and a are as defined above for compositions of Formula A.

In a further aspect of the invention, there is provided a curable hot melt composition including the reaction product of a diisocyanate and an aminoalkylenealkoxy terminated polydialkylsiloxane.

In still a further aspect of the present invention there is provided a process for making a moisture curable composition which includes the steps of:
a. providing a mixture of:
   i) a first reactant including a diisocyanate; and
   ii) a second reactant including an aminoalkylenealkoxy terminated polyalkylsiloxane; and
b. reacting the first and second reactants to form the moisture curable composition.

In yet another method of the present invention there is provided a method of improving the high-temperature physical properties of a curable hot melt adhesive which includes the steps of:
a. providing a curable hot melt composition having polymer chain segments capable of hydrogen bonding, said polymer chain segments being flanked by pendant moisture curing groups; and
b. exposing the hot melt composition to curing conditions, whereby the polymer chain segments capable of hydrogen bonding are held in sufficient proximity to each other to permit hydrogen bonding.

In yet another method of the present invention there is provided a method of using a curable hot melt adhesive including the steps of:
a. providing a sealed container of an adhesive composition which includes:
   i. a curable hot adhesive having the structure A(II):

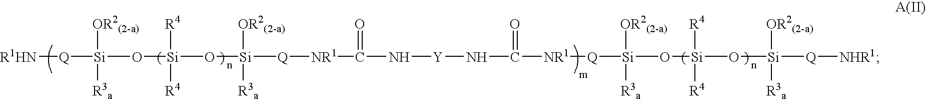

b. heating the adhesive to a temperature sufficient to permit dispensing of the adhesive; and
c. dispensing the adhesive onto a substrate and permitting the adhesive to cure,
wherein Q, Y, R¹, R², R³, R⁴, a, n, and m are as discussed above for compositions of Formula A.

In yet another aspect of the present invention there is provided a hot melt adhesive product, which includes:
a. a moisture resistant container capable of housing and/or dispensing a moisture curable hot melt adhesive; and
b. a moisture curable hot melt adhesive located with said container.

### B) Rheology Controlled Silicone-Containing Compositions

In some aspects, the present invention provides compositions which behave like a hot melt initially, but transform into a crosslinked composition when exposed to moisture. Improved control of the rheology of the compositions is provided by the use of chain-extenders and chain-terminators in the preparation of the compositions.

In one aspect of the present invention, there is provided a composition which includes a polymer of Formula B(I):

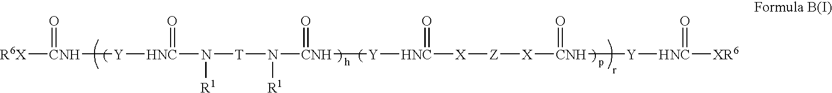

In another aspect, there present invention provides a composition including a polymer of Formula B(II):

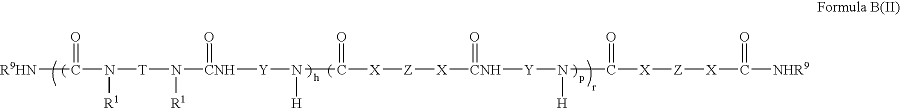

In still another aspect, the present invention provides a composition which includes a polymer of Formula B(III):

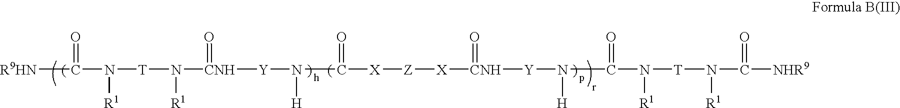

In yet another aspect, the present invention provides a composition which includes a polymer of Formula B(IV):

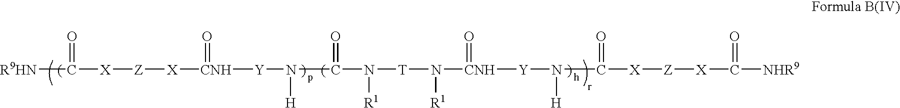

The present invention also provides a composition which includes the reaction product of:
a) a composition of the formula:

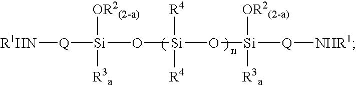

b) a compound having the formula:

OCN—Y—NCO;
c) a compound having the formula:

HX-Z-XH; and
d) a compound having the formula;

R⁶—X—H

In another aspect, the present invention provides a composition which includes the reaction product of:
a) a composition of the formula:

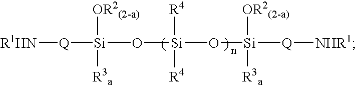

b) a compound having the formula:

OCN—Y—NCO;

c) a compound having the formula:

HX-Z-XH; and
d) a compound having the formula;

R⁹—NCO

The present invention also provides a method for making a composition, the method including reacting:
a) a composition of the formula:

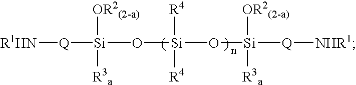

b) a compound having the formula:

OCN—Y—NCO;
c) a compound having the formula:

HX-Z-XH; and

d) a compound having the formula;

R⁶—X—H

In another aspect, the present invention provides a method for making a composition, the method including reacting:
a) a composition of the formula:

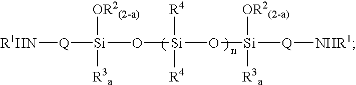

b) a compound having the formula:

OCN—Y—NCO;
c) a compound having the formula:

HX-Z-XH; and
d) a compound having the formula;

R⁹—NCO

The present invention also provides a method of using a composition, the method including the steps of:
a) providing a sealed container of a composition of Formula B(I)

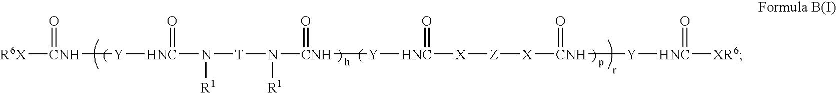

b) heating the composition of Formula B(I) to a temperature sufficient to permit dispensing of the composition; and
c) dispensing the composition of Formula B(I) onto a substrate and permitting the composition to cure.

In another aspect, the present invention provides a method of using a composition, the method including the steps of:
a) providing a sealed container of at least one of a composition of Formula B(II), B(III), or B(IV):

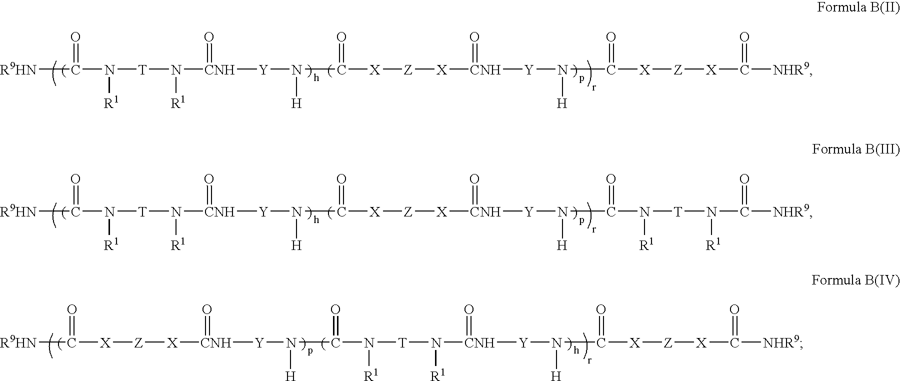

b) exposing the composition of step a) to a temperature sufficient to permit the composition to be flowable; and
c) applying the composition of step b) onto a substrate and permitting the composition to cure.

In each of Formulas B(I), B(II), B(III), and B(IV):
R¹ in each occurrence may be the same or different and is a member selected from the group consisting of H and a C₁ to C₁₀ hydrocarbon radical;
R⁶ in each occurrence may be the same or different and is a member selected from the group consisting of H and a C₁ to C₁₀ hydrocarbon radical;
R⁹ in each occurrence may be the same or different and is a C₁ to C₁₀ hydrocarbon radical;
T in each occurrence may be the same or different and is:

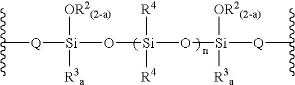

wherein
   R² in each occurrence may be the same or different and is a C₁ to C₁₀ hydrocarbon radical;
   R³ in each occurrence may be the same or different and is a C₁ to C₁₀ hydrocarbon radical;
   R⁴ in each occurrence may be the same or different and is a C₁ to C₁₀ hydrocarbon radical;
   Q in each occurrence may be the same or different and is a C₁ to C₁₀ hydrocarbon diradical;
   n in each occurrence may be the same or different and is 1 to about 1,200; and
   a in each occurrence may be the same or different and is 0 or 1;
Y in each occurrence may be the same or different and is a C₁ to C₂₀ hydrocarbon diradical;
Z in each occurrence may be the same or different and is a C₁ to C₂₀ hydrocarbon diradical;
X in each occurrence may be the same or different and is a member selected from the group consisting of O, S, and NR⁵,
   wherein R⁵ in each occurrence may be the same or different and is a member selected from the group consisting of H, a C₁ to C₁₀ hydrocarbon radical, and (R⁷O)_{b}SiR⁸_{(3-b)}-Q-,
      wherein
         R⁷ in each occurrence may be the same or different and is C₁ to C₁₀ alkyl;
         R⁸ in each occurrence may be the same or different and is C₁ to C₁₀ alkyl;
         b in each occurrence may be the same or different and is 0, 1, or 2;
h is 1 to about 100;
p is 0 to about 100; and
r is 1 to about 100.

### C) Radiation and Moisture Curable Silicone-Containing Compositions

In some aspects, the present invention relates to photo- and moisture-curable thermoplastic polymers.

In one aspect of the present invention, there is provided a composition which includes a polymer of Formula C(I):

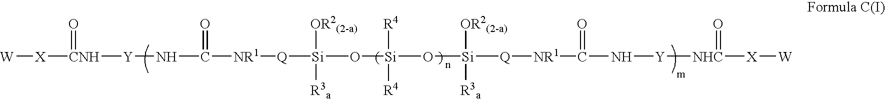

In another aspect of the present invention, there is provided a composition which includes a polymer of Formula C(III):

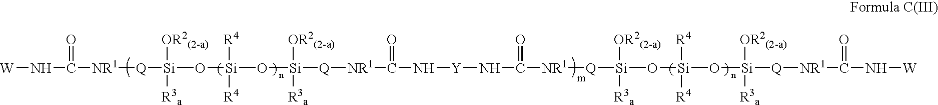

The invention also provides a composition which is the reaction product of:
a) a composition of Formula C(IV):

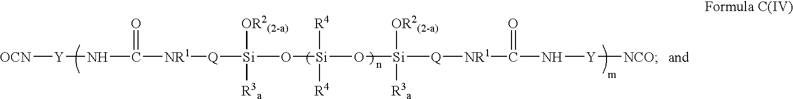

b) a compound having the structure:

W—X—H

In yet another aspect, there is provided by the present invention a composition including the reaction product of:
a) a composition having the formula:

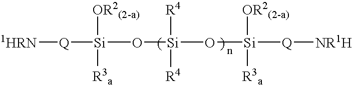

b) a compound having the structure:

OCN—Y—NCO; and
c) a compound having the formula:

W—NCO

Yet another aspect of the present invention provides a composition comprising the reaction product of:
a) a composition having the formula:

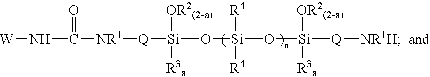

b) a compound having the structure:

OCN—Y—NCO

In each of the above representations for Formula C,
R¹ in each occurrence may be the same or different and is a member selected from the group consisting of H and a C₁ to C₁₀ hydrocarbon radical;
R¹ in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical;
X in each occurrence can be the same or different and is a member selected from the group consisting of O, S, and NR¹⁰,
   wherein R¹⁰ in each occurrence may be the same or different and is a member selected from the group consisting of H and a C₁ to C₁₀ hydrocarbon radical;
Y in each occurrence may be the same or different and is a C₁ to C₂₀ hydrocarbon diradical;
W in each occurrence may be the same or different and is C₂ to C₁₀ hydrocarbon radical capable of free-radical polymerization containing at least one of: a double bond, a carbonyl group, or an epoxide group;
Q in each occurrence may be the same or different and is a C₁ to C₁₀ hydrocarbon diradical;
n in each occurrence may be the same or different and is 1 to about 1,200;
m is 1 to about 100; and
a in each occurrence may be the same or different and is 0 or 1.

### BRIEF DESCRIPTION OF THE FIGURES

FIG. 1 is a graphic representation of the viscosity/temperature relationship during heating and cooling of a composition of the present invention of Formulas A.

FIG. 2 is a graphic representation of thermogravimetric analysis performed on two inventive compositions of Formulas A as compared to a commercially available thermoplastic silicone.

FIG. 3 is a schematic representation of the hydrogen bonding which is possible due to the relative positioning of the crosslinking groups and the hard segments of the reactive polymers of Formulas A.

FIG. 4 shows the reactants used in the synthesis of compositions of Formula B(I).

FIG. 5 shows the reactants used in the synthesis of compositions of Formulas B(II), B(III), and B(IV).

FIG. 6 depicts compositions of Formula C(I) and Formula C(II), obtained from a siloxane starting material.

FIG. 7 depicts a general synthetic pathway leading to formation of compositions of Formula C(I).

FIG. 8 depicts the various pathways by which compositions of Formula C(III) may be obtained.

FIG. 9 shows compositions of Formula C(III) obtained through the simultaneous chain extension of the siloxane with a diisocyanate, and end-capping with a monoisocyanate.

FIG. 10 shows compositions of Formula C(III) obtained by end-capping one side of the siloxane with a monoisocyanate followed by chain extension with a diisocyanate

FIG. 11 shows compositions of Formula C(III) obtained by chain extension of the siloxane with a diisocyanate followed by end-capping with a monoisocyanate, via an amine-terminated intermediate.

### DETAILED DESCRIPTION OF THE INVENTION

The compositions of the present invention are designed to be heated during use such that they can be rendered flowable and be dispensed from their container. In this sense they are similar to conventional thermoplastic hot melts. In contrast to conventional thermoplastic hot melts, however, once the composition is exposed to moisture curing conditions, the composition will cure, i.e., crosslink, to form a thermoset material. Thus, prior to use, the inventive compositions are packaged in containers or dispensers which are substantially impermeable to air and moisture in order to prevent premature cure. The compositions desirably are in the non-flowable form, i.e., solid or semi-solid form, in the sealed container, the container being capable of being heated to render the inventive composition contained within dispensable. The amount of composition to be dispensed can be appropriately metered onto a desired substrate and then allowed to moisture cure under ambient conditions. Any composition remaining in the sealed container or dispenser can be allowed to cool and resolidify for future use. Thus, a convenient, curable hot melt composition is achieved.

As used herein, the terms “hydrocarbon radical” and “hydrocarbon diradical” are intended to refer to radicals and diradicals, respectively, which are primarily composed of carbon and hydrogen atoms. Thus, the terms encompass aliphatic groups such as alkyl, alkenyl, and alkynyl groups; aromatic groups such as phenyl; and alicyclic groups, such as cycloalkyl and cycloalkenyl.

Hydrocarbon radicals and diradicals of the invention may include heteroatoms to the extent that the heteroatoms do not detract from the hydrocarbon nature of the groups. Accordingly, hydrocarbon groups may contain heteroatoms such as halogens, oxygen, nitrogen, and sulfur. Thus, hydrocarbon groups may include such functional groups as ethers, alkoxides, carbonyls, esters, amino groups, amido groups, cyano groups, sulfides, sulfates, sulfoxides, and sulfones.

### A) Compositions of Formula A

The present inventive compositions are directed to silicone urea hot melt compositions that contain moisture curable alkoxysilyl groups. Representative compositions of the present invention are indicated by Formula A(II):

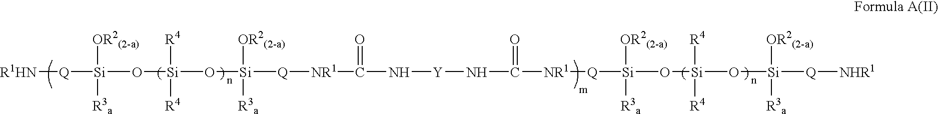

Q in each occurrence may be the same or different and is a C₁ to C₁₀ hydrocarbon radical. Advantageously, Q is C₁ to C₁₀ alkylene. In a particularly advantageous aspect, Q is methylene, propylene, or isobutylene.

Y in each occurrence may be the same or different and is a C₁ to C₂₀ hydrocarbon diradical. The hard segments of the polymer backbone are obtained from the diisocyanate starting material useful in preparation of the compositions of the invention. Y represents the hydrocarbon portion of the diisocyanate starting material. Illustrative of these diisocyanates are phenyl diisocyanate, toluene diisocyanate, 4,4′-diphenyl diisocyanate, 4,4′-diphenylene methane diisocyanate, dianisidine diisocyanate, 1,5-naphtalene diisocyanate, 4,4′-diphenyl ether diisocyanate, p-phenylene diisocyanate, 4,4′-dicyclohexylmethane diisocyanate, 1,3-bis-(isocyanatomethyl)cyclohexane, cyclohexylene diisocyanate, tetrachlorophenylene diisocyanate, 2,6-diethyl-p-phenylenediisocyanate, 3,5-diethyl-4,4′-diisocyanatodiphenyl-methane, isophorone diisocyanate, hexamethylene diisocyanate, and 1,3-bis(cyanatomethyl)cyclohexane. Combinations of diisocyanates may also be used. In an advantageous aspect, the diisocyanate may be one of isophorone diisocyanate, hexamethylene diisocyanate, or 1,3-bis(cyanatomethyl)cyclohexane.

R¹ in each occurrence may be the same or different and is a member selected from the group consisting of H and C₁ to C₁₀ alkyl. In one aspect of the present invention, R¹ of compositions of Formula A(II) may be chosen from C₁-C₁₀ alkyl. These groups may also be substituted if desired. For example, one useful substitution is —CH₂CH₂—O—CH₃. In a desirable aspect, R¹ is C₁ to C₆ alkyl. More desirably, R¹ is H, ethyl, or propyl.

R² in each occurrence may be the same or different, and is a C₁ to C₁₀ hydrocarbon radical. Substituent R², in combination with the oxygen to which it is attached, forms a hydrolyzable group, which provides the compositions of the present invention with their ability to undergo room temperature vulcanization (RTV). RTV cure typically occurs through exposure of the compositions of the present invention to moisture. The presence of hydrolyzable moisture curing groups, such as alkoxy groups, on the silicone backbone permits the compositions of the invention to undergo moisture cure. Suitable hydrolyzable groups include alkoxy groups such as methoxy, ethoxy, propoxy, and butoxy, aryl groups such as phenoxy; acyloxy groups such as acetoxy, aryloxy groups such as phenoxy, and alkoxyalkyl groups such as CH₃OCH₂CH₂—. Larger groups such as propoxy and butoxy are slower to react than smaller groups such as methoxy and ethoxy. Accordingly, the rate at which the compositions of the invention undergo moisture cure can be influenced by choosing appropriately sized groups for substituent R². Desirably, R² is C₁ to C₄ alkyl. More desirably, R² is methyl or ethyl.

R³ in each occurrence may be the same or different and is a C₁ to C₁₀ hydrocarbon radical. R³ is desirably C₁ to C₄ alkyl. More particularly, R³ is desirably methyl.

R⁴ in each occurrence may be the same or different and is a C₁ to C₁₀ hydrocarbon radical. R⁴ is desirably C₁ to C₄ alkyl. In most commercial applications, R⁴ will desirably be methyl, due to the wide availability of the polydimethylsiloxane starting material which is advantageously used in the synthesis of the compositions of the invention. In another desirable aspect, R⁴ may also be phenyl.

Variable “a” in each occurrence may be the same or different and is 0 or 1. “m” in each occurrence may be the same or different, and is 1 to about 100.

In an advantageous aspect of compositions of Formula A(II), R¹ is C₁ to C₆ alkyl, R² is C₁ to C₄ alkyl, R³ is C₁ to C₄ alkyl, and R⁴ is C₁ to C₄ alkyl.

In another advantageous aspect of compositions of Formula A(II), Q is a C₁ to C₁₀ alkyl diradical, Y is a C₁ to C₁₀ alkyl diradical, Z is a C₁ to C₁₀ alkyl diradical, and X is a member selected from the group consisting of NH, N(C₁ to C₅ alkyl) and N(C₁ to C₈ aryl).

Additionally, substitution of the alkyl group of R¹-R⁴ is also contemplated.

In one particularly useful aspect of the invention, compositions of Formula A(II) have the following specific substitutions: R¹ is ethyl; R² is methyl; R³ is methyl; R⁴ is methyl; Q is isobutylene; and Y is the hydrocarbyl portion of a diisocyanate selected from isophorone diisocyanate, hexamethylene diisocyanate, and 1,3-bis(cyanatomethyl)cyclohexane.

Another aspect of the present invention relates to a curable hot melt composition which is the reaction product of a diisocyanate and a siloxane of Formula A(I):

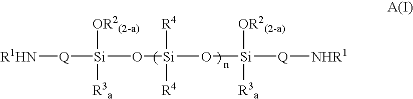

wherein R¹, R², R³, R⁴, a, and n are as discussed above for compositions of Formula A.

The diisocyanates useful in the present invention are those of the formula:

OCN—Y—NCO

wherein Y is as discussed above for compositions of Formula A.

Illustrative of these diisocyanates are phenyl diisocyanate, toluene diisocyanate, 4,4′-diphenyl diisocyanate, 4,4′-diphenylene methane diisocyanate, dianisidine diisocyanate, 1,5-naphtalene diisocyanate, 4,4′-diphenyl ether diisocyanate, p-phenylene diisocyanate, 4,4′-dicyclohexylmethane diisocyanate, 1,3-bis-(isocyanatomethyl)cyclohexane, cyclohexylene diisocyanate, tetrachlorophenylene diisocyanate, 2,6-diethyl-p-phenylenediisocyanate, 3,5-diethyl-4,4′-diisocyanatodiphenyl-methane, isophorone diisocyanate, hexamethylene diisocyanate, and 1,3-bis(cyanatomethyl)cyclohexane.

It is advantageous for the diisocyanate to be one of isophorone diisocyanate, hexamethylene diisocyanate, or 1,3-bis(cyanatomethyl)cyclohexane. Combinations of diisocyanates may also be used.

The compositions of the present invention include both hard and soft segments along the polymer backbone. The silicone segments are considered soft, flexible segments and the segments attributable to the diisocyanate starting material are considered the relatively hard segments.

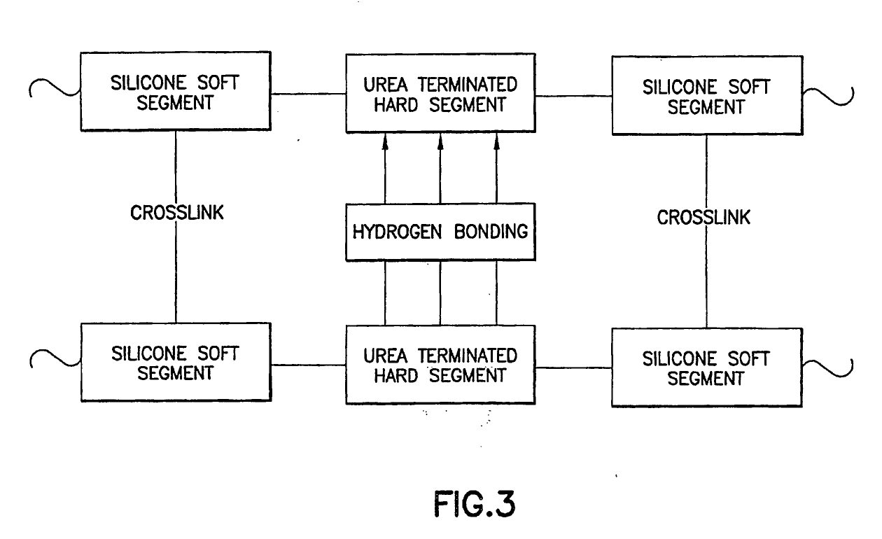

The compositions of the present invention are structurally designed, i.e., the crosslinking sites are positioned on the polymer, such that upon cure the hard segments are forced in close proximity to each other. This positioning results in increased physical properties at higher temperatures due to the resultant hydrogen bonding between adjacent hard segments. The cured compositions of the present invention thus achieve not only physical properties attributable to crosslinking, but increased physical properties due to the additional molecular attraction as a result of segments capable of hydrogen bonding being forced into close proximity with each other as crosslinking occurs. FIG. 3 shows in schematic form the relative positions of curing groups to hard segments.

As a result of the structural design of the hard segments being at positions intermediate to the crosslinking groups, the cured polymers exhibit improved physical properties at temperatures of greater than 150° C. Whereas conventional non-reactive hot melt adhesives usually flow at temperatures of about 100° C., cured samples of the present invention have sustained their solidity and physical strength after more than a month at 150° C.

Although primary amines may be used in making the amino-terminated silicone reactant of the present invention, they are less preferable than secondary amines due to the former's higher tendency for undesirable side-reactions, e.g. biuret formation.

In preparation of the compositions of the present invention, aminoalkylenealkoxy terminated polydialkylsiloxanes are reacted with a diisocyanate. The aminoalkylenealkoxy terminated polydialkylsiloxanes may be formed as described in U.S. Pat. No. 6,750,309 B1, assigned to Henkel Corporation which is incorporated herein in its entirety. As seen from this reference, these reactants can be formed by reacting alkylaminoalkylene trialkoxysilanes with hydroxy-terminated polydimethylsiloxane (“PDMS”). The product of this reaction results in the aminoalkylenealkoxy-terminated polydialkylsiloxanes. Column 12, Example XI of the '309 patent describes these compounds in more detail.

Particularly useful examples of aminoalkylenealkoxy terminated polydialkylsiloxanes include ethylaminopropyltrirethoxysilane and aminopropyltrimethoxysilane.

The polyalkylsiloxane is desirably chosen from those easily found commercially, such as silanol terminated polydimethylsiloxanes. The molecular weights of these silicon fluids may vary and may be chosen to tailor the final product characteristics. The number of repeating units, n, can be varied to achieve specific molecular weight, viscosities, and other chemical or physical properties. Generally, n is an integer such that the viscosity is from about 25 cps to about 2,500,000 cps at 25° C., such as when n is from 1 to about 1,200 and desirably from 10 to about 1,000. Examples of useful molecular weights of the polyalkylsiloxanes include molecular weights of 500 to about 50,000 atomic mass units. Advantageously, the average molecular weight of the siloxane of structure A(I) is about 1,000 atomic mass units to about 30,000 atomic mass units.

Compositions of the present invention may include amine compounds separate and apart from the amino-terminated ends of the siloxane reactant. For example, diamines such as ethylenediamine may be employed.

A further aspect of the present invention relates to a curable hot melt composition comprising the reaction product of a diisocyanate and an aminoalkylenealkoxy terminated polydialkylsiloxane, wherein the amino portion of the aminoalkylenealkoxy terminated polydialkylsiloxane is desirably a secondary amine. Advantageously, the aminoalkylenealkoxy terminated polydialkylsiloxane is selected from ethylaminoisobutyltrimethoxysilane, ethylaminoisobutyltriethoxysilane, butylaminopropyltrimethoxysilane, butylaminopropyltriethoxysilane, aminopropyltrimethoxysilane, aminopropyltriethoxysilane and combinations thereof. More advantageously, the polydialkylsiloxane portion of the polymer is polydimethylsiloxane.

Another aspect of the present invention provides a process for making a moisture curable composition involving:
a. providing a mixture of:
   i. a first reactant including a diisocyanate; and
   ii. a second reactant including an aminoalkylenealkoxy terminated polyalkylsiloxane; and
b. reacting the first and second reactants to form the moisture curable composition.

The diisocyanate and the aminoalkylenealkoxy terminated polyalkylsiloxane are as described above.

Another aspect of the present invention provides a method of improving the high-temperature physical properties of a curable hot melt adhesive including the steps of:
a. providing a moisture curable hot melt composition having polymer chain segments capable of hydrogen bonding, said polymer chain segments being flanked by pendant moisture curing groups; and
b. exposing the hot melt composition to curing conditions,
   whereby the polymer chain segments capable of hydrogen bonding are held in sufficient proximity to each other to permit hydrogen bonding.

A further aspect of the present invention provides a method of using a curable hot melt adhesive including the steps of:
a. providing a sealed container of an adhesive composition including:
   i. a curable hot adhesive having the Formula A(II)

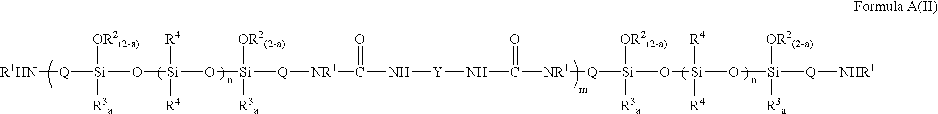

wherein R¹, R², R³, R⁴, Q, Y, n, m, and a are as discussed above for compositions of Formula A;
b. heating the adhesive to a temperature sufficient to permit dispensing of the adhesive; and
c. dispensing the adhesive onto a substrate and permitting the adhesive to cure.

The compositions of the present invention are designed to be packaged into containers, dispensers or cartridges which are substantially resistant to moisture and air in order to prevent undesirable premature crosslinking. The cartridges are made from materials which can be subjected to temperatures of up to 150° C. or more without loss of their ability to dispense in order to melt the reactive hot melt composition contained therein. For example, aluminum cartridges may be particularly useful.

Yet another aspect of the present invention provides a hot melt adhesive product which includes:
a. a moisture resistant container capable of housing and/or dispensing a moisture curable hot melt adhesive; and
b. a moisture curable hot melt adhesive located with said container.

Advantageously, the moisture curable hot melt adhesive corresponds to structure A(II):

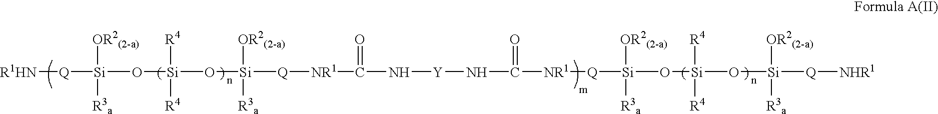

wherein R¹, R², R³, R⁴, Q, Y, m, n, and a are as discussed above for compositions of Formula A.

The present invention is also directed to compositions that are the reaction product of water and compositions of Formula A(II). Compositions of Formula A(II) do not require added moisture curing catalysts, due to the self-catalyzing effect of the amino groups. Optionally, however, the inventive compositions may include moisture curing catalysts to further enhance or control the cure speed. Suitable moisture-cure catalysts include metal compounds which contain such metals as titanium, tin, or zirconium. Illustrative examples of titanium compounds include tetraisopropoxy titanate and tetrabutoxy titanate. Illustrative examples of the tin compounds include dibutyltin dilaurate, dibutyltin diacetate, dioctyltindicarboxylate, dimethyltindicarboxylate, and dibutyltin dioctoate. Illustrative examples of the zirconium compounds include zirconium octanoate. The moisture-cure catalysts may be employed in an amount sufficient to promote moisture-cure, which generally is from about 0.05% to about 5.00% by weight, and advantageously from about 0.5% to about 2.5% by weight. Tin octoate, dibutyltin dilaurate, tetraisopropoxy titanate and tetrabutoxy titanate are particularly desirable. U.S. Pat. No. 4,111,890 lists numerous others that are useful.

A variety of additional useful components may be added to the present inventive compositions. For example, reactive and non-reactive diluents may be added. Such diluents include, without limitation, isobornyl (meth)acrylate, dimethylacrylamide, (meth)acrylic acid and vinyl trimethoxysilane. Other useful additives include plasticizers, fillers, viscosity modifiers, flow modifiers, pigments, stabilizers, inhibitors, adjuvants, catalysts, accelerators, thixotropic agents and combinations thereof. These additives should be present in amounts suitable to effectuate their intended purpose.

### B) Compositions of Formula B

In one aspect, the present invention is directed towards silicone-containing compositions with enhanced rheology control.

### Compositions of Formula B(I)

Typical compositions of the present invention are indicated by Formula (I):

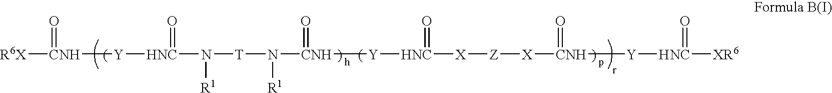

The compositions of the present invention include both hard and soft segments along the polymer backbone. T provides the soft-segments, of the compositions of Formula B(I). T in each occurrence may be the same or different and is:

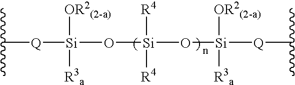

The silicone segments provided by T are considered to be pliant and flexible segments.

Y in each occurrence may be the same or different and is a C₁ to C₂₀ hydrocarbon diradical. The hard segments of the polymer backbone are obtained from the diisocyanate starting material useful in preparation of the compositions of the invention. Y represents the hydrocarbon portion of the diisocyanate starting material. Illustrative of these diisocyanates are phenyl diisocyanate, toluene diisocyanate, 4,4′-diphenyl diisocyanate, 4,4′-diphenylene methane diisocyanate, dianisidine diisocyanate, 1,5-naphtalene diisocyanate, 4,4′-diphenyl ether diisocyanate, p-phenylene diisocyanate, 4,4′-dicyclohexylmethane diisocyanate, 1,3-bis-(isocyanatomethyl)cyclohexane, cyclohexylene diisocyanate, tetrachlorophenylene diisocyanate, 2,6-diethyl-p-phenylenediisocyanate, 3,5-diethyl-4,4′-diisocyanatodiphenyl-methane, isophorone diisocyanate, hexamethylene diisocyanate, and 1,3-bis(cyanatomethyl)cyclohexane. Combinations of diisocyanates may also be used. In an advantageous aspect, the diisocyanate may be one of isophorone diisocyanate, hexamethylene diisocyanate, or 1,3-bis(cyanatomethyl)cyclohexane.

Q in each occurrence may be the same or different and is a C₁ to C₁₀ hydrocarbon radical. Advantageously, Q is C₁ to C₁₀ alkylene. In a particularly advantageous aspect, Q is methylene, propylene, or isobutylene.

X in each occurrence may be the same or different and is a member selected from the group consisting of O, S, and NR⁵,
wherein R⁵ in each occurrence may be the same or different and is a member selected from the group consisting of H, C₁ to C₁₀ hydrocarbon radical, and (R⁷O)_{b}SiR⁸_{(3-b)}-Q-,
   wherein
      R⁷ in each occurrence may be the same or different and is C₁ to C₁₀ alkyl;
      R⁸ in each occurrence may be the same or different and is C₁ to C₁₀ alkyl;
      b in each occurrence may be the same or different and is 0, 1, or 2.

X is included in both the chain-extenders and chain-terminators of the present invention. X represents the heteroatom which reacts with the isocyanate groups which may be used in preparation of the compositions of the invention. Advantageously, X is O, NH, N(C₁ to C₅ alkyl) or N(C₁ to C₈ aryl).

Z in each occurrence may be the same or different and is a C₁ to C₂₀ hydrocarbon diradical. Z represents the hydrocarbon portion of the chain-extenders which may be used in preparation of compositions of the invention. Advantageously, Z is C₁ to C₅ alkylene, such as ethylene and butylene.

R¹ in each occurrence may be the same or different and is a member selected from the group consisting of H and C₁ to C₁₀ alkyl. In a desirable aspect, R¹ is C₁ to C₆ alkyl More desirably, R¹ is H, ethyl, or propyl.

R² in each occurrence may be the same or different, and is a C₁ to C₁₀ hydrocarbon radical. Substituent R², in combination with the oxygen to which it is attached, forms a hydrolyzable group, which provides the compositions of the present invention with their ability to undergo room temperature vulcanization (RTV). RTV cure typically occurs through exposure of the compositions of the present invention to moisture. The presence of hydrolyzable moisture curing groups, such as alkoxy groups, on the silicone backbone permits the compositions of the invention to undergo moisture cure. Suitable hydrolyzable groups include alkoxy groups such as methoxy, ethoxy, propoxy, and butoxy; aryl groups such as phenoxy; acyloxy groups such as acetoxy; aryloxy groups such as phenoxy; and alkoxyalkyl groups such as CH₃OCH₂CH₂—. Larger groups such as propoxy and butoxy are slower to react than smaller groups such as methoxy and ethoxy. Accordingly, the rate at which the compositions of the invention undergo moisture cure can be influenced by choosing appropriately sized groups for substituent R². Desirably, R² is C₁ to C₄ alkyl. More desirably, R² is methyl or ethyl.

R³ in each occurrence may be the same or different and is a C₁ to C₁₀ hydrocarbon radical. R³ is desirably C₁ to C₄ alkyl. More particularly, R³ is desirably methyl.

R⁴ in each occurrence may be the same or different and is a C₁ to C₁₀ hydrocarbon radical. R⁴ is desirably C₁ to C₄ alkyl. In most commercial applications, R⁴ will desirably be methyl, due to the wide availability of the polydimethylsiloxane starting material which is advantageously used in the synthesis of the compositions of the invention. In another desirable aspect, R⁴ may also be phenyl.

R⁶ in each occurrence may be the same or different and is a member selected from the group consisting of H and a C₁ to C₁₀ hydrocarbon radical. Desirably, R⁶ is C₁ to C₆ alkyl. More desirably, R⁶ is H.

In an advantageous aspect of compositions of Formula B(I), R¹ is C₁ to C₆ alkyl, R² is C₁ to C₄ alkyl, R³ is C₁ to C₄ alkyl, R⁴ is C₁ to C₄ alkyl, and R⁶ is C₁ to C₆ alkyl.

In another advantageous aspect of compositions of Formula B(I), Q is a C, to C₁₀ alkyl diradical, Y is a C₁ to C₁₀ alkyl diradical, Z is a C₁ to C₁₀ alkyl diradical, and X is a member selected from the group consisting of NH, N(C₁ to C₅ alkyl) and N(C₁ to C₈ aryl).

Also representative of compositions of the invention are those of Formulas B(II), B(III), and B(IV):

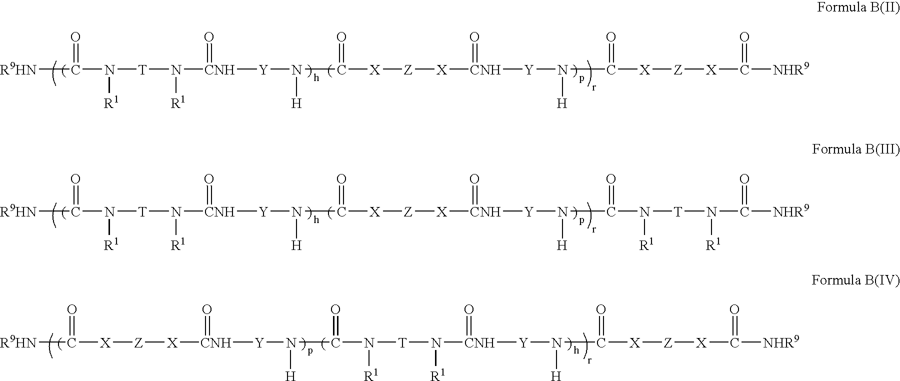

wherein R¹, R², R³, R⁴, Q, X, Y, Z, a, h, p, r, and n are as discussed above for compositions of Formula B(I), and R⁹ in each occurrence may be the same or different and is a C₁ to C₁₀ hydrocarbon radical.

The present invention is also directed to compositions that are the reaction product of water and at least one of Formulas B(I), B(II), B(III), and B(IV). The compositions of Formulas B(I), B(II), B(III), and B(IV) do not require added moisture curing catalysts due to the self-catalyzing effect of the amino groups. Optionally, however, the inventive compositions may include moisture curing catalysts to further enhance, or control the cure speed. Suitable moisture-cure catalysts include metal compounds which contain such metals as titanium, tin, or zirconium. Illustrative examples of titanium compounds include tetraisopropoxy titanate and tetrabutoxy titanate. Illustrative examples of the tin compounds include dibutyltin dilaurate, dibutyltin diacetate, dioctyltindicarboxylate, dimethyltindicarboxylate, and dibutyltin dioctoate. Illustrative examples of the zirconium compounds include zirconium octanoate. The moisture-cure catalysts may be employed in an amount sufficient to promote moisture-cure, which generally is from about 0.05% to about 5.00% by weight, and advantageously from about 0.5% to about 2.5% by weight.

The compositions of the present invention may be cured at ambient temperatures or at elevated temperatures.

A variety of additional useful components may be added to the present inventive compositions, so long as they do not interfere with the moisture curing mechanism. For example, reactive and non-reactive diluents may be added. Such diluents include, without limitation, isobornyl methacrylate, dimethacrylamide, methacrylic acid and vinyl trimethoxysilane. Other useful additives include plasticizers, fillers, viscosity modifiers, flow modifiers, pigments, stabilizers, inhibitors, adjuvants, catalysts, accelerators, thixotropic agents, and combinations thereof. These additives should be present in amounts suitable to effectuate their intended purpose.

The compositions of the present invention are designed to be packaged into containers, dispensers, or cartridges which are substantially resistant to moisture and air in order to prevent undesirable premature crosslinking. The cartridges of the invention are made from materials which can be subjected to temperatures of up to 150° C. or more without loss of their ability to dispense in order to melt the reactive hot melt composition contained therein. For example, aluminum cartridges are particularly useful.

The compositions of Formula B can be used in a variety of applications, including those where high temperature resistance and high physical properties are needed. Illustrative examples of such uses include automotive headlamp bonding, and as sealants for stove tops. In one aspect, a method of using a composition of the invention includes the steps of:
a) providing a sealed container of at least one of a composition of Formulas B(I), B(II), B(III), and B(IV),
b) exposing the composition to a temperature sufficient to permit the composition to be flowable; and
c) applying the composition onto a substrate and permitting the composition to cure.

In another aspect, the present invention is directed to an article of manufacture which includes two substrates bonded together by a composition of any of Formulas B(I), B(II), B(III), or B(IV).

### Preparation of the Compositions of Formula B

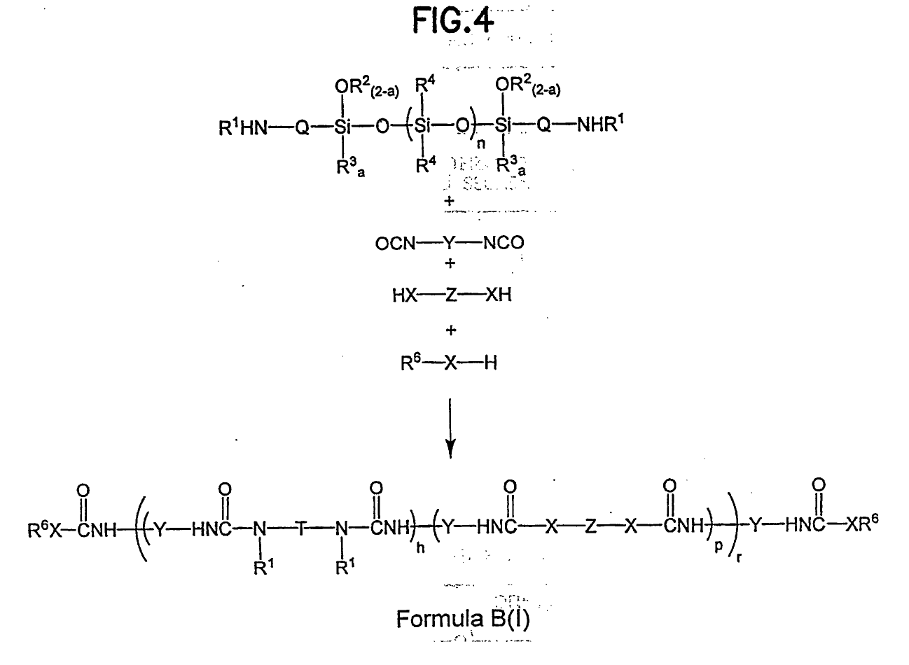

As can be seen in FIG. 4, compositions of Formula B(I) may be prepared by mixing:
a) a siloxane of the formula:

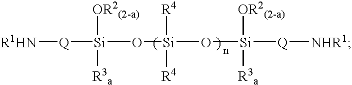

b) a diisocyanate having the formula:

OCN—Y—NCO;
c) a chain-extender having the formula:

HX-Z-XH; and

d) a chain-terminator having the formula;

R⁶—X—H

wherein R¹, R², R³, R⁴, R⁶, Q, X, Y, Z, a, and n are as discussed above for compositions of Formula A. Accordingly, the present invention relates to both this method and to compositions that are the reaction product of this method.

As noted above, the siloxane used in preparation of the compositions of Formula A provides the soft segment portion of the compositions. The siloxane may be formed as described in U.S. Pat. No. 6,750,309 B1, assigned to Henkel corporation, which is incorporated herein in its entirety. As seen from this reference, trialkoxysilanes can be reacted with, for example, polydimethylsiloxane, producing a suitable siloxane. Illustrative of the siloxanes used in the present invention are ethylaminoisobutyltrimethoxysilane, ethylaminoisobutyltrimethoxysilane, butylaminopropyltrimethoxysilane, butylaminopropyltrimethoxysilane, aminopropyltrimethoxysilane, aminopropyltrimethoxysilane, and combinations thereof. Particularly useful examples of such siloxanes include ethylaminopropyltrimethoxysilane and cyclohexylaminomethyltrimethoxysilane.

The siloxane is desirably chosen from those easily found commercially available, such as polydimethylsiloxanes. The number of repeating units, n, can be varied to achieve specific molecular weights, viscosities, and other chemical or physical properties. Generally n is an integer such that the viscosity is from about 25 cps to about 2,500,000 cps at 25° C., such as when n is from 1 to about 1,200 and desirably from 10 to about 1,000. The molecular weights of these siloxanes may vary and may be chosen to tailor the final product characteristics. Examples of useful molecular weights of the polyalkylsiloxanes include molecular weights of 500 to about 50,000 atomic mass units. Advantageously, the average molecular weight of the siloxane is about 1,000 atomic mass units to about 30,000 atomic mass units.

The chain-extenders of the invention react with the isocyanate and increases the hard segment content, thus increasing the viscosity and the melting range of the inventive compositions. The chain-extenders contain a diisocyanate as discussed above for compositions of Formula B.

The chain-terminators of the invention serve to limit the growth of the copolymer chain, which accordingly lowers the viscosity and melting range of the polymers. The chain-terminators useful for preparation of compositions of Formula B(I) contain a single group capable of reaction with an isocyanate group, such as an amino group, a hydroxy group, or a thiol group.

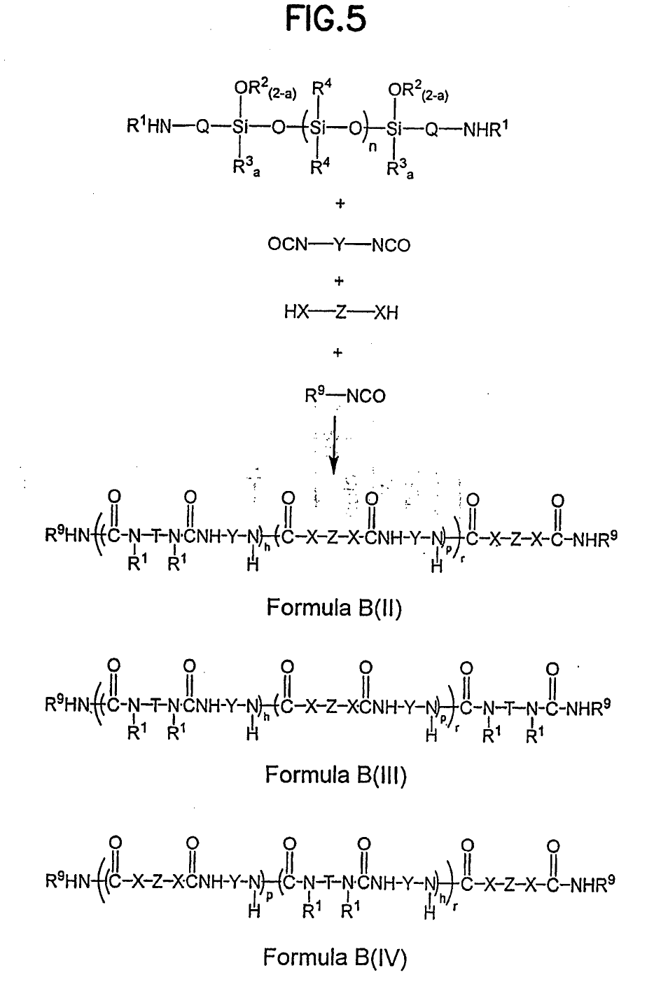

As can be seen in FIG. 5, compositions of Formulas B(II), B(III), and B(IV) may be prepared by mixing:
a) a siloxane of the formula:

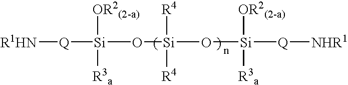

b) a diisocyanate having the formula:

OCN—Y—NCO
c) a chain-extender having the formula:

HX-Z-XH
d) a chain-terminator having the formula;

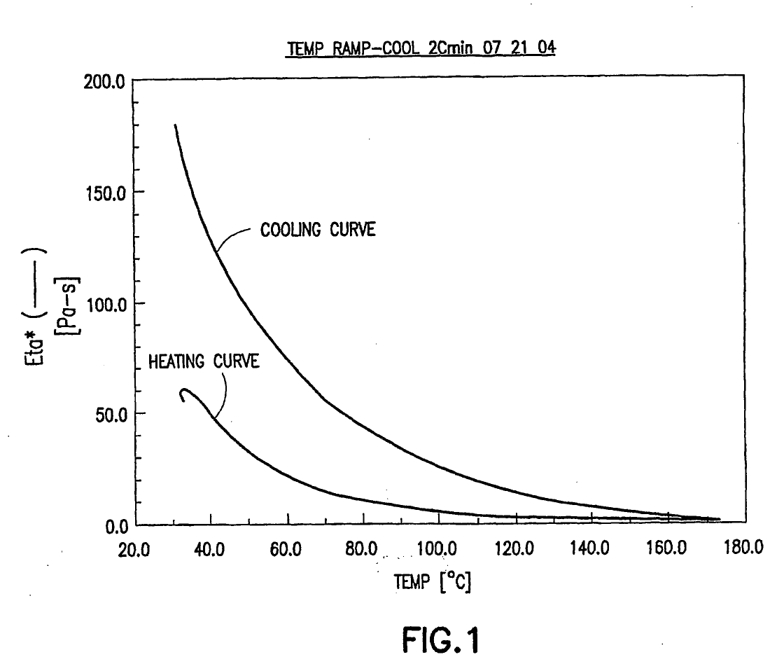

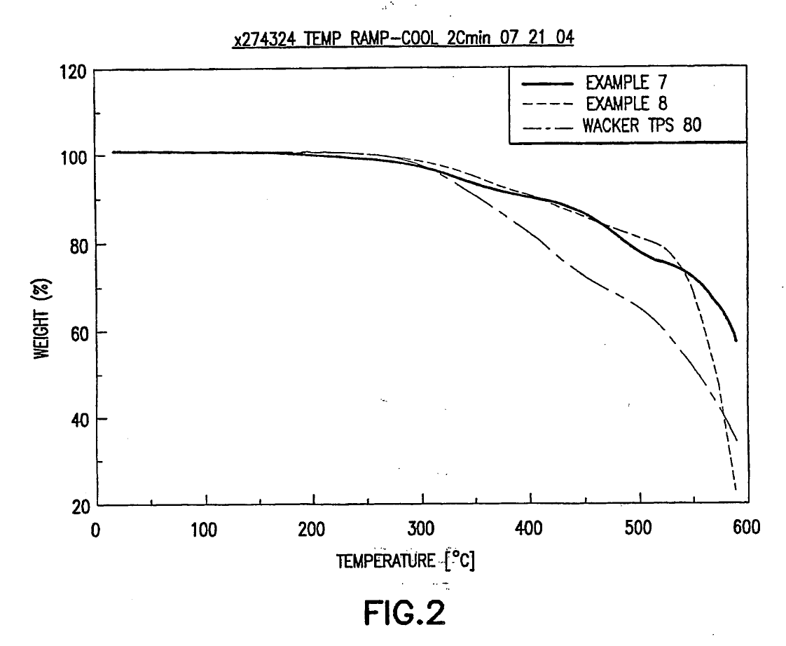

R⁹—NCO

wherein the siloxane, the diisocyanate, the chain-extender, and the substituents R¹, R², R³, R⁴, R⁹, Q, X, Y, Z, a, and n are as discussed above for compositions of Formula B. Accordingly, the present invention relates to both this method and to compositions that are the reaction product of this method.

Whereas the method for preparing compositions of Formula B(I) uses chain-terminator of the formula, R⁶—X—H, the method for preparing of compositions of Formulas B(II), B(III), and B(IV) uses instead an isocyanate of the formula R⁹—NCO, as shown in FIGS. 1 and 2. When such an isocyanate is used, three products may be formed: 1) those of Formula B(II) in which the two ends are different from one another, one being obtained from reaction of the isocyanate with the amine of the siloxane, and one being obtained from reaction of the isocyanate and the chain extender; 2) those of Formula B(III) in which both ends are the reaction product of the isocyanate and the amine group of the siloxane; and 3) those of Formula B(IV) in which both ends are reaction products of the isocyanate with one end of the chain extender. The above reaction in which the R⁹—NCO isocyanate is used will generally result in a mixture of Formulas B(II), B(II), and B(IV). By adjusting reaction conditions, compositions of Formulas B(II), B(III), and B(IV) may be obtained in varying amounts.

### C) Compositions of Formula C

In some aspects, the present invention is directed to silicone-containing compositions which are capable of both radiation and moisture-cure. Compositions of Formula C provide a hot melt composition which can be dispensed at high temperature. After dispensing, the composition rapidly gains green strength by cooling or more preferably by radiation curing. The dispensed material can further undergo a secondary moisture curing to form a crosslinked network which can be used for high temperature applications.

Typical compositions of the present invention are indicated by Formula C(I):

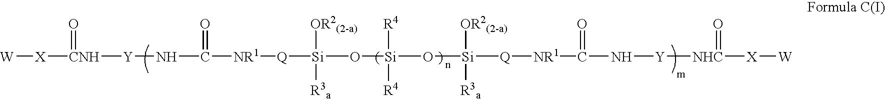

Q in each occurrence may be the same or different and is a C₁ to C₁₀ hydrocarbon radical. Advantageously, Q is C₁ to C₁₀ alkylene. In a particularly advantageous aspect, Q is methylene, propylene, or isobutylene.

The compositions of Formula C include both hard and soft segments along the polymer backbone. The soft-segments may be provided by the portion of the formula corresponding to the segment below:

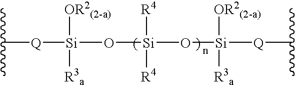

These segments are considered to be pliant and flexible segments.
W in each occurrence may be the same or different and is C₂ to C₁₀ hydrocarbon radical capable of free-radical polymerization known to those skilled in the art. Desirably, W contains at least one of: a double bond, a carbonyl group, or an epoxide group. Examples of functional groups which are encompassed by substituent W include, but are not limited to: epoxy, vinyl, alkylvinyl, acryloxy, alkylacryloxy, allylic, alkylallylic, alkylvinyl, alkylalkynyl, and azo. Advantageously, substituent W, and substituent X to which it is attached, form a methacryloxy group.
X in each occurrence may be the same or different and is a member selected from the group consisting of O, S, and NR¹⁰,
wherein R¹⁰ in each occurrence may be the same or different and is a member selected from the group consisting of H and a C₁ to C₁₀ hydrocarbon radical.
   Y in each occurrence may be the same or different and is a C₁ to C₂₀ hydrocarbon diradical. The hard segments of the polymer backbone are obtained from the diisocyanate starting material useful in preparation of the compositions of the invention. Y represents the hydrocarbon portion of the diisocyanate starting material. Illustrative of these diisocyanates are phenyl diisocyanate, toluene diisocyanate, 4,4′-diphenyl diisocyanate, 4,4′-diphenylene methane diisocyanate, dianisidine diisocyanate, 1,5-naphtalene diisocyanate, 4,4′-diphenyl ether diisocyanate, p-phenylene diisocyanate, 4,4′-dicyclohexylmethane diisocyanate, 1,3-bis-(isocyanatomethyl)cyclohexane, cyclohexylene diisocyanate, tetrachlorophenylene diisocyanate, 2,6-diethyl-p-phenylenediisocyanate, 3,5-diethyl-4,4′-diisocyanatodiphenyl-methane, isophorone diisocyanate, hexamethylene diisocyanate, and 1,3-bis(cyanatomethyl)cyclohexane. Combinations of diisocyanates may also be used. In an advantageous aspect, the diisocyanate may be one of isophorone diisocyanate, hexamethylene diisocyanate, or 1,3-bis(cyanatomethyl)cyclohexane.
   R¹ in each occurrence may be the same or different and is a member selected from the group consisting of H and C₁ to C₁₀ alkyl. In a desirable aspect, R¹ is C₁ to C₆ alkyl. More desirably, R¹ is H, ethyl, or propyl.
   R² in each occurrence may be the same or different, and is a C₁ to C₁₀ hydrocarbon radical. Substituent R², in combination with the oxygen to which it is attached, forms a hydrolyzable group, which provides the compositions of the present invention with their ability to undergo room temperature vulcanization (RTV). RTV cure typically occurs through exposure of the compositions of the present invention to moisture. The presence of hydrolyzable moisture curing groups, such as alkoxy groups, on the silicone backbone permits the compositions of the invention to undergo moisture cure. Suitable hydrolyzable groups include alkoxy groups such as methoxy, ethoxy, propoxy, and butoxy; aryl groups such as phenoxy; acyloxy groups such as acetoxy, and alkoxyalkyl groups such as CH₃OCH₂CH₂—. Larger groups such as propoxy and butoxy are slower to react than smaller groups such as methoxy and ethoxy. Accordingly, the rate at which the compositions of the present invention undergo moisture cure can be influenced by choosing appropriately sized groups for substituent R². Desirably, R² is C₁ to C₄ alkyl. More desirably, R² is methyl or ethyl.

R³ in each occurrence may be the same or different and is a C₁ to C₁₀ hydrocarbon radical. R³ is desirably C₁ to C₄ alkyl. More particularly, R³ is desirably methyl.

R⁴ in each occurrence may be the same or different and is a C₁ to C₁₀ hydrocarbon radical. R⁴ is desirably C₁ to C₄ alkyl. In most commercial applications, R⁴ will desirably be methyl, due to the wide availability of the polydimethylsiloxane starting material which is advantageously used in the synthesis of the compositions of the invention.

In advantageous aspect, compositions of Formula C(I) are of Formula C(II):

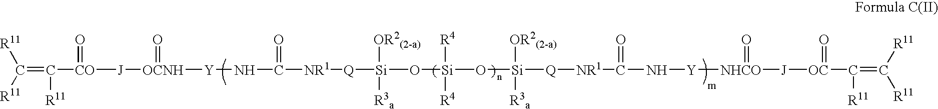

wherein R¹ is C₁ to C₆ alkyl, R² is C₁ to C₄ alkyl, R³ is C₁ to C₄ alkyl, R⁴ is C₁ to C₄ alkyl, 3 in each occurrence may be the same or different and is a C₁ to C₁₀ hydrocarbon diradical, and R¹¹ in each occurrence may be the same or different and is a member selected from the group consisting of H and C₁ to C₄ alkyl.

Also representative of the compositions of Formula C are those of Formula C(III):

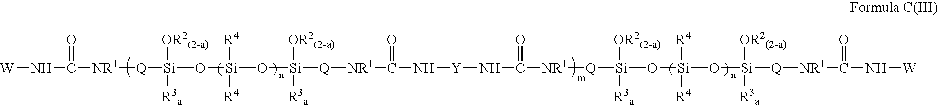

wherein R¹, R², R³, R⁴, Q, Y, W, a, n, and m are as discussed above for compositions of Formula C.

In an advantageous aspect of compositions of Formula C(III), R¹ is C₁ to C₆ alkyl, R² is C₁ to C₄ alkyl, R³ is C₁ to C₄ alkyl, R⁴ is C₁ to C₄ alkyl, and W is

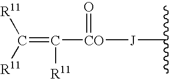

wherein J in each occurrence may be the same or different and is a C₁ to C₁₀ hydrocarbon diradical; and R¹¹ in each occurrence may be the same or different and is a member selected from the group consisting of H and C₁ to C₄ alkyl.

The present invention is also directed to compositions that are the reaction product of water and compositions of at least one of Formulas C(I) and C(III). The inventive compositions may optionally include moisture curing catalysts to further enhance or control the cure speed. Suitable moisture-cure catalysts include metal compounds which contain such metals as titanium, tin, or zirconium. Illustrative examples of titanium compounds include tetraisopropoxy titanate and tetrabutoxy titanate. Illustrative examples of the tin compounds include dibutyltin dilaurate, dibutyltin diacetate, dioctyltindicarboxylate, dimethyltindicarboxylate, and dibutyltin dioctoate. Illustrative examples of the zirconium compounds include zirconium octanoate. The moisture-cure catalysts may be employed in an amount sufficient to promote moisture-cure, which generally is from about 0.05% to about 5.00% by weight, and advantageously from about 0.5% to about 2.5% by weight. Tin octoate, dibutyltin dilaurate, tetraisopropoxy titanate and tetrabutoxy titanate are particularly desirable. U.S. Pat. No. 4,111,890 lists numerous others that are useful.

A variety of additional useful components may be added to the present inventive compositions of Formula C. For example, reactive and non-reactive diluents may be added. Such diluents include, without limitation, isoformyl(meth)acrylate, dimethylacrylamide, (meth)acrylic acid and vinyltrimethoxysilane. Other useful additives include plasticizers, fillers, viscosity modifiers, flow modifiers, pigments, stabilizers, inhibitors, adjuvants, catalysts, accelerators, thixotropic agents, and combinations thereof. These additives should be present in amounts suitable to effectuate their intended purpose.

The compositions of Formula C can be used in a variety of applications, including those where high temperature resistance is needed. Illustrative examples of such uses include automotive and general industrial applications. In one aspect, a method of using a composition of the invention includes the steps of:
a) providing a sealed container of at least one of a composition of Formulas C(I) and C(III),
b) exposing the composition to a temperature sufficient to permit the composition to be flowable; and
c) applying the composition onto a substrate and permitting the composition to cure.

In another aspect, the present invention is directed to an article of manufacture which includes two substrates bonded together by a composition of any of Formulas C(I) or C(III).

### Preparation of the Compositions of Formula C

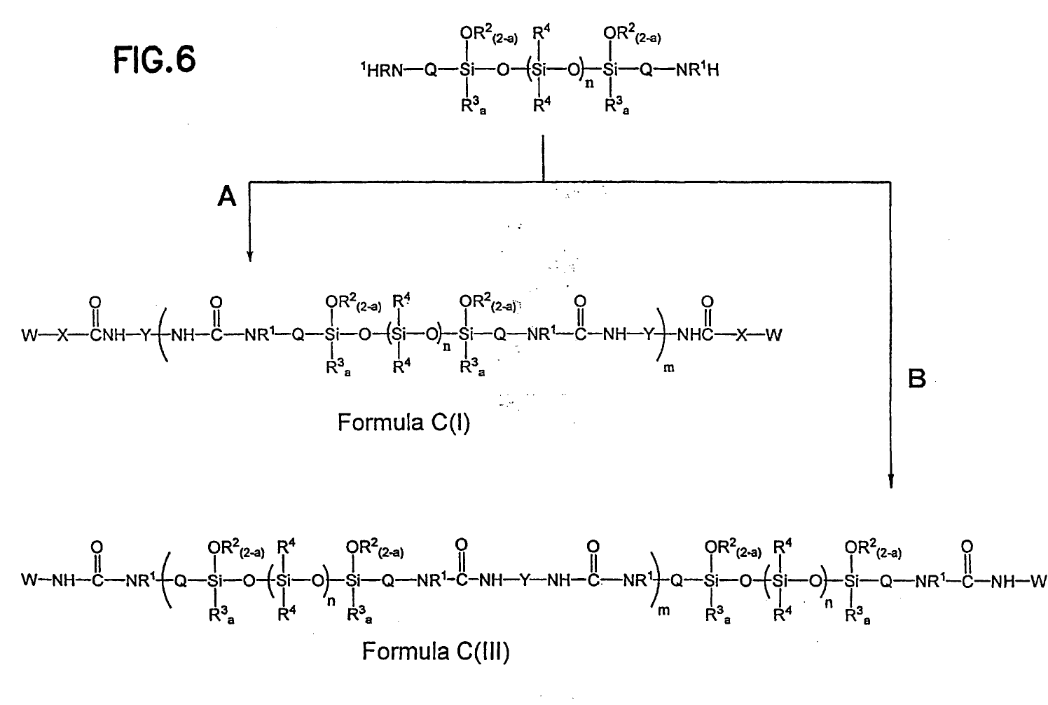

As can be seen in FIG. 6, the siloxane shown therein may be used to prepare compositions of Formulas C(I) and C(III), via pathways A and B, respectively.

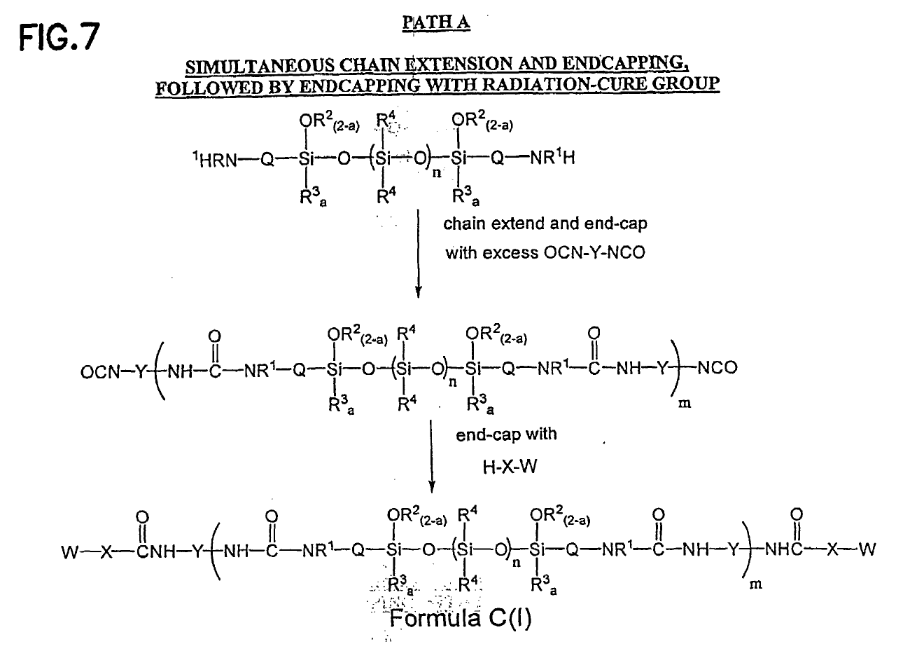

As can be seen in FIG. 7, compositions of Formula C(I) may be prepared via pathway A by mixing:
a) a composition having the formula:

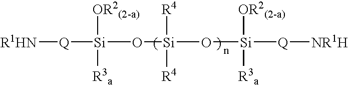

b) a compound having the structure:

OCN—Y—NCO

wherein Y is a C₁ to C₂₀ hydrocarbon diradical; and
c) a compound having the formula:

W—X—H

wherein Q, W, X, Y, R¹, R², R³, R⁴, and n are as discussed above for compositions of Formula C. Accordingly, the present invention relates to both this method and to compositions that are the reaction product of this method.

As noted above, the siloxane used in preparation of the compositions of the invention provide the soft segment portion of the compositions. The siloxane may be formed as described in U.S. Pat. No. 6,750,309 B1, assigned to Henkel Corporation, which is incorporated herein in its entirety. As seen from this reference, trialkoxysilanes can be reacted with a hydroxyl terminated polydihydrocarbylsiloxane, such as polydimethylsiloxane, producing a suitable siloxane. Illustrative of the silanes used in the present invention are ethylaminoisobutyltrimethoxysilane, butyl aminopropyltrimethoxysilane, aminopropyltrimethoxysilane, and combinations thereof. Particularly useful examples of such silanes include ethylaminoisobutyltrimethoxysilane and cyclohexylaminomethyltrimethoxysilane.

The hydroxyl terminated polydihydrocarbylsiloxane is desirably chosen from those easily found commercially available. The number of repeating units, n, can be varied to achieve specific molecular weights, viscosities, and other chemical or physical properties. Generally, n is an integer such that the viscosity is from about 25 cps to about 2,500,000 cps at 25° C., such as when n is from 1 to about 1,200, and desirably from 10 to about 1,0000. The molecular weight of these siloxanes may vary and may be chosen to tailor the final product characteristics. Examples of useful molecular weights of the polyalkylsiloxanes include molecular weights of about 500 to about 50,000 atomic mass units. Advantageously, the average molecular weight of the siloxane is about 1,000 atomic mass units to about 30,000 atomic mass units.

In one aspect, the siloxane is reacted with the diisocyanate, producing the chain extended diisocyanate intermediate C(IV) shown in FIG. 7. This intermediate is then end-capped on both sides, providing compounds of Formula C(I). Accordingly, the present invention relates to both compositions of Formula C(IV) and to compositions which are the reaction product of:
a) a composition of Formula C(IV):

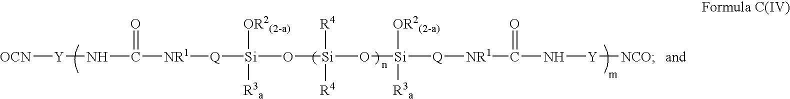

b) a compound having the structure:

W—X—H
wherein Q, W, Y, R¹, R², R³, R⁴, a, m, and n are as discussed above for compositions of Formula C.

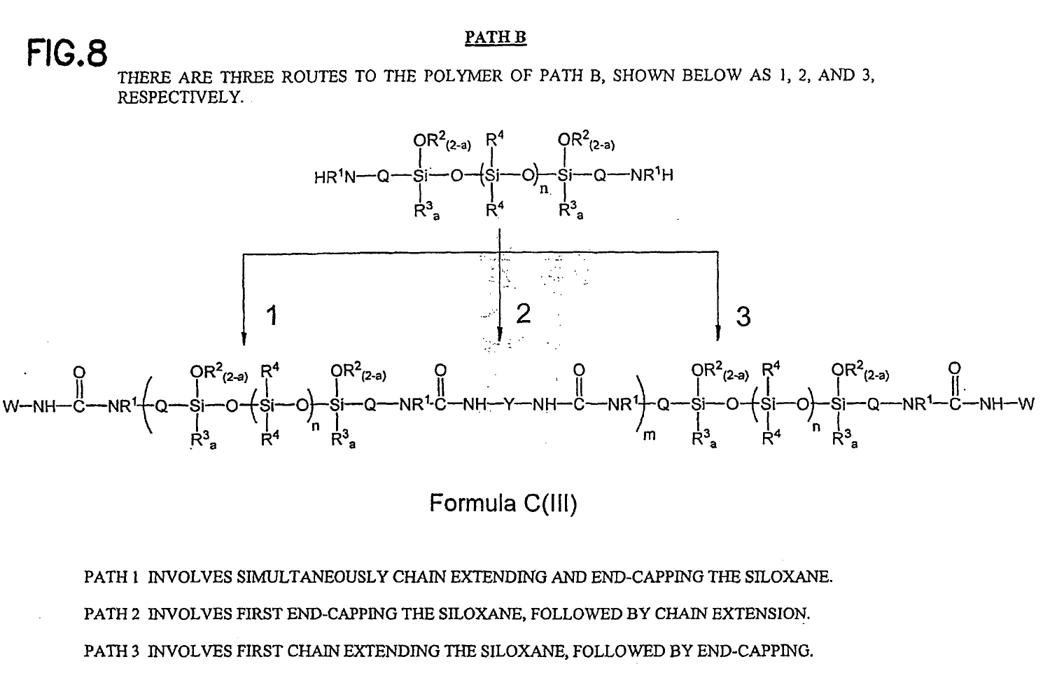

Alternatively, the siloxane may be used to prepare compositions of Formula C(III), as shown in FIG. 8. As can be seen, compositions of Formula C(III) may be prepared via three pathways, all of which use a combination of the siloxane, monoisocyanate, and diisocyanate. Accordingly, the present invention relates to a method for making a composition, the method including the steps of mixing:
a) a composition having the formula:

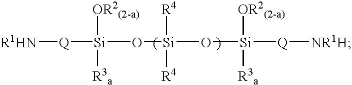

b) a compound having the structure:

OCN—Y—NCO; and
c) a having the formula:

W—NCO
wherein Q, Y, W, R¹, R², R³, R⁴ a, and n are as defined above for compositions of Formula C.

The present invention also relates to, compositions that are the reaction product of:
a) a composition having the formula:

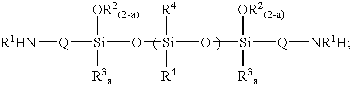

b) a compound having the structure:

OCN—Y—NCO; and
c) a compound having the formula:

W—NCO
wherein Q, Y, W, R¹, R², R³, R⁴ a, and n are as defined above for compositions of Formula C.

The monoisocyanate and diisocyanate may be used in any ratio, so long as there is provided enough monoisocyanate and diisocyanate to ensure complete reaction of the siloxane starting material. Desirably, the monoisocyanate and diisocyanate will be used in a ratio of 1:10 to 10:1. Advantageously, the monoisocyanate and diisocyanate will be used in a ratio of 50:50.

Typically, when the necessary starting materials are mixed together, compositions of Formula C(III) will be produced via more than one of the pathways. However, the reaction conditions may be adjusted in order to promote one pathway over the others. For example, while the siloxane, monoisocyanate, and diisocyanate may all be mixed together simultaneously, other reaction conditions are also contemplated.

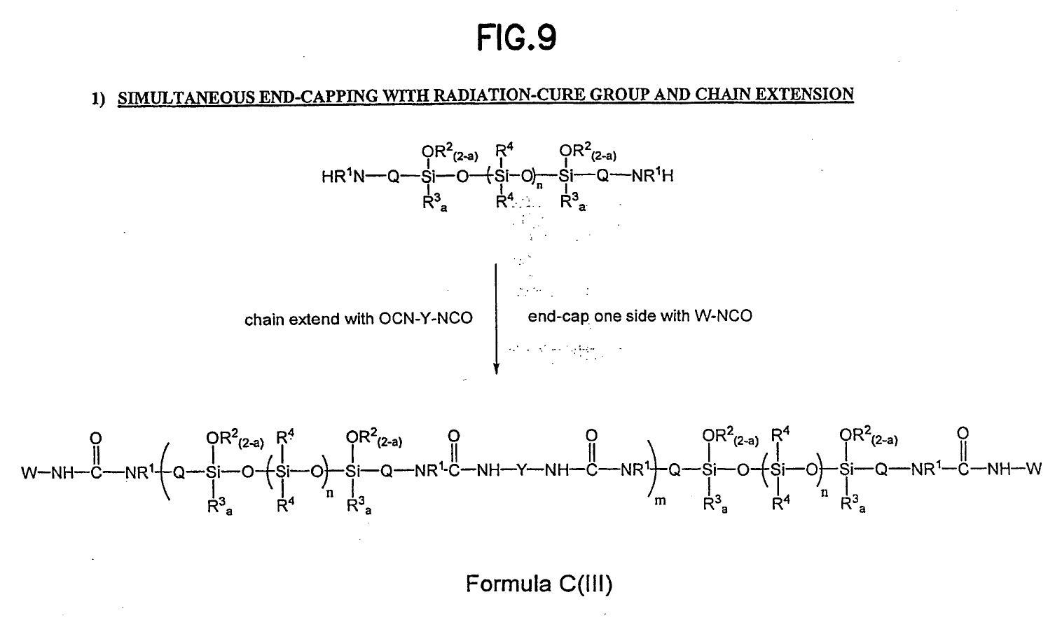

FIG. 9 depicts the first pathway, in which the chain-extension with the diisocyanate, and end-capping of the siloxane with the monoisocyanate occurs simultaneously.

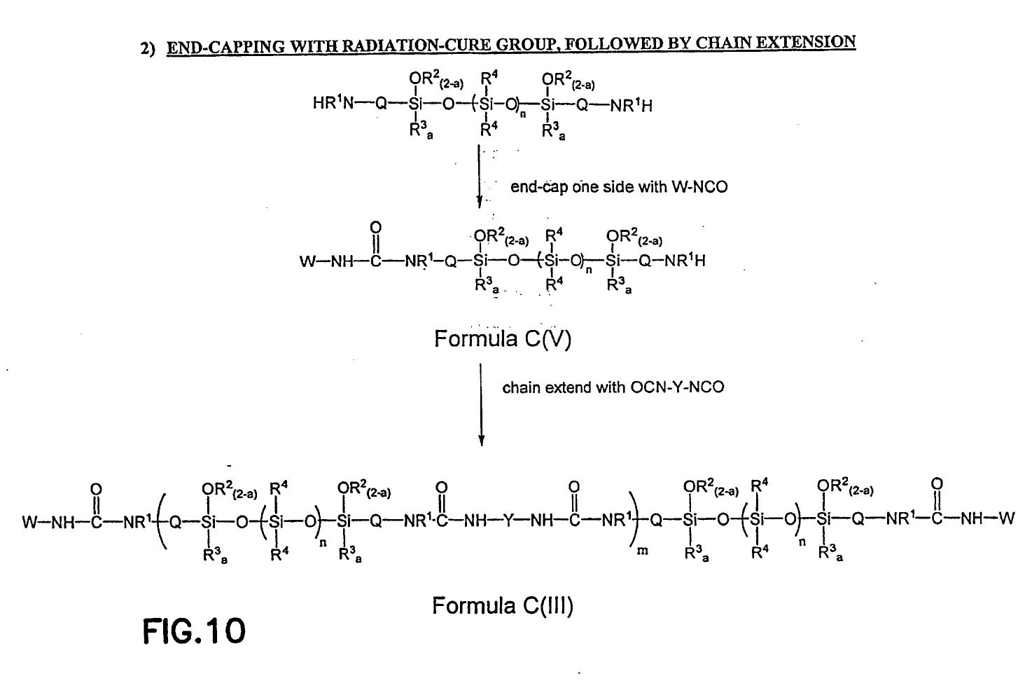

FIG. 10 depicts the second pathway, in which the siloxane is end-capped with the monoisocyanate before any chain-extension occurs, producing the intermediate composition of Formula C(V):

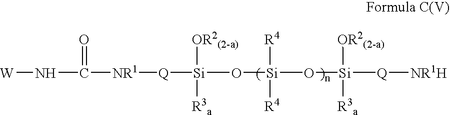

wherein R¹, R², R³, R⁴, Q, and W are as discussed above. This intermediate compound is then chain extended, providing compositions of Formula C(III). While such a reaction pathway can occur when the siloxane, monoisocyanate, and diisocyanate are simultaneously mixed, it is also contemplated that the reaction pathway can occur in two discrete steps. The siloxane may be first exposed to only the monoisocyanate, providing the compositions of Formula C(V) shown above. Accordingly, the present invention relates to compositions of Formula C(V) and methods used to make such compositions. The compositions of Formula C(V) may then be reacted with the diisocyanate, providing compositions of Formula C(III). Accordingly, the present invention relates both to a method of making compositions, the method including the steps of mixing:
a) a composition having the formula:

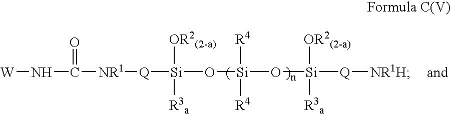

b) a compound having the structure:

OCN—Y—NCO;
wherein Q, Y, W, R¹, R², R³, R⁴ a, and n are as defined above for compositions of Formula C.

The present invention also relates to compositions that are the reaction product of:
a) a composition having the formula:

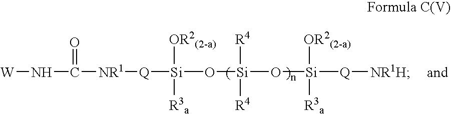

b) a compound having the structure:

OCN—Y—NCO;
wherein Q, Y, W, R¹, R², R³, R⁴ a, and n are as defined above for compositions of Formula C.

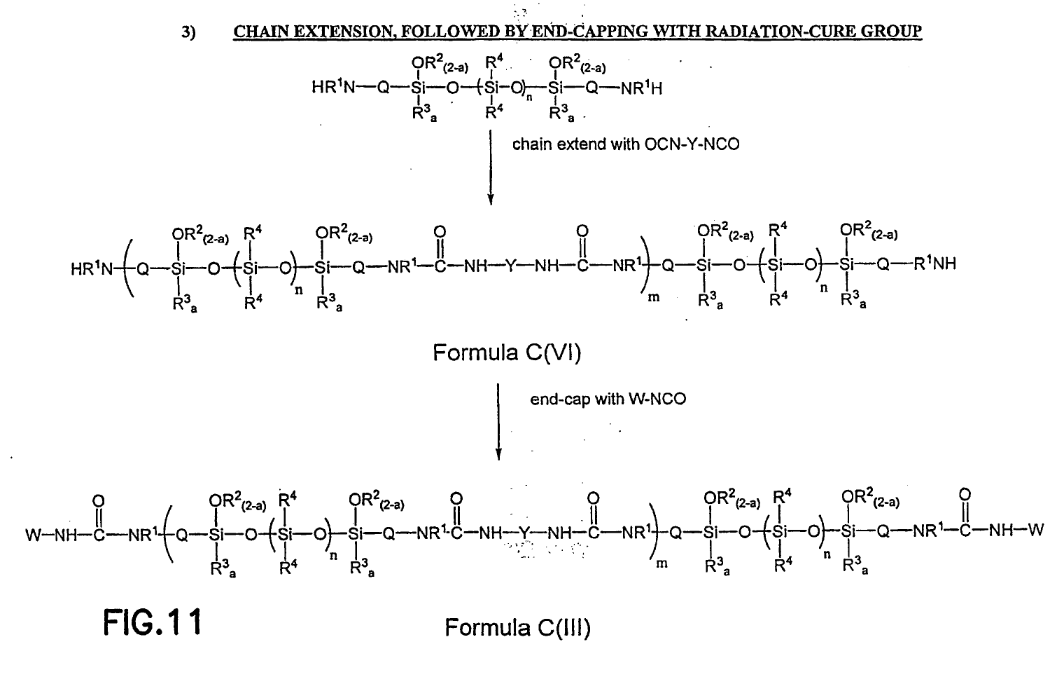

FIG. 11 depicts the third pathway, in which the siloxanes of the present invention in which the siloxane is first chain extended with the diisocyanate, forming intermediate compositions of Formula C(VI):

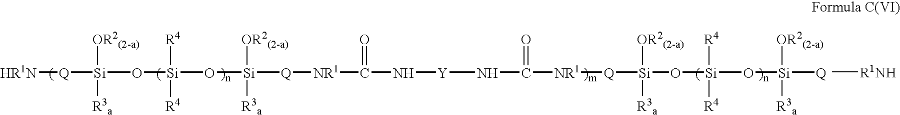

The compositions of Formula C(VI) are then end-capped with the mono-isocyanate, providing compositions of Formula C(III). Accordingly, the present invention relates to a method of making compositions, the method including the steps of reacting:
a) a composition having the formula:

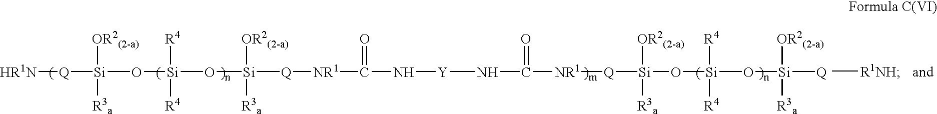

b) a compound having the formula:

W—NCO
wherein Q, Y, W, R¹, R², R³, R⁴ a, and n are as defined above for compositions of Formula C.

The present invention also relates to compositions that are the reaction product of:
a) a composition having the formula:

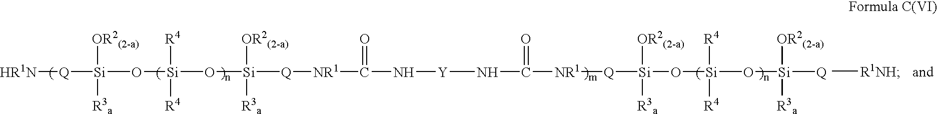

b) a compound having the formula:

W—NCO
wherein Q, Y, W, R¹, R², R³, R⁴ a, and n are as defined above for compositions of Formula C.

### EXAMPLES

The following examples provide specific illustrations of various aspects of the present invention. In no way should the invention be construed as being limited to these particular examples.

### Compositions of Formula A

### Fluid A

### Synthetic Example of Ethylaminoisobutyldimethoxy Terminated Polydimethylsiloxane

In a 5 liter three neck round bottom flask was charged with 2,004 g of a 100 cps hydroxyl terminated polydimethylsiloxane and 265.73 g of ethylaminoisobutyltrimethoxysilane (A-Link 15 from GE). The mixture was heated to 70° C. with stirring and vacuum stripping for 1 hour. Fluid A has an amine content of 0.537 mmoles/g

### Fluid B

### Synthetic Example of Aminopropyldimethoxy Terminated Polydimethylsiloxane

In a 2 liter three neck round bottom flask was charged with 1000.4 g of a 100 cps hydroxyl terminated polydimethylsiloxane and 90 g of aminopropyltrimethoxysilane. The mixture was heated to 70° C. with stirring and vacuum stripping for 1 hour. Fluid B has an amine content of 0.473 mmoles/g.

### Fluid C

In a 1 liter three neck round bottom flask was charged with 505 g of a 750 cps hydroxyl terminated polydimethylsiloxane and 18.6 g of ethylaminoisobutyltrimethoxysilane. The mixture was heated to 70° C. with stirring and vacuum stripping for 1 hour. Fluid C has an amine content of 0.162 mmoles/g.

### Example A1

In a 1 liter 3 neck round bottom flask was charged with a solution containing 167.80 g of Fluid A in 137.8 g of butyl acetate. A solution of 10 g of isophorone diisocyanate in 40 g of butylacetate was then slowly dropped into the round bottom flask with vigorous stirring over 10 minutes. The mixture gelled shortly after the complete addition of the diisocyanate. An additional 167.8 g of butylacetate then was further added. The mixture was further heated to 120° C. with stirring to redissolve the gel.

A film was cast from this solution via solvent evaporation. The film after standing in ambient environment for 7 days was fully cured and could not be redissolved by butylacetate.

### Example A2

In a 250 mL open beaker was placed with 104 g of Fluid A. Isophorone diisocyanate (5.77 g) was slowly added in fractions over 5 minutes with vigorous stirring. Mixture became warm to the touch and formed a viscous gel within minutes after complete addition of the diisocyanate. The reaction product was flowable after heating to 120° C. and was transferred into a tightly capped glass jar. The product is a hot melt that flowed upon heating but solidified upon cooling to room temperature.

A piece of film was cast from the molten liquid product. The film after standing overnight at ambient conditions was cured and did not flow upon further heating.

### Example A3

### Comparison Example Using Primary Amine which Resulted in Premature Crosslinking

In a 500 mL 3 neck round bottom flask was charged with a solution of 47.5 g of Fluid B in 100 g of butylacetate. A solution of 2.50 g of isophorone diisocyanate in 50 mL butylacetate was slowly dropped in with vigorous stirring. The reaction mixture became increasingly more viscous when approximately 50% of the amine solution was added. The mixture gelled when 77% of the amine solution was added and the reaction was stopped. This was a clear indication of premature crosslinking.

The mixture upon heating remained a gel. The gel could not be redissolved in butylacetate.

### Example A4

In a 300 mL 3-neck round bottom flask was charged with a solution of 50 g of Fluid C in 80 g of butylacetate. A solution of 0.90 g of isophorone diisocyanate in 21.8 g of butylacetate was dropped into the flask with vigorous stirring. The temperature of the mixture rose from 21° C. to 24° C. during the addition. The product was a clear solution.

A film was cast from the solution via solvent evaporation. The cast film was fully cured after 7 days and could not be redissolved by butylacetate.

### Example A5

### Comparison Example Using Primary Amine from Both Ethylenediamine and Amino Functional PDMS Resulted in Premature Crosslinking

In a 500 mL 3-neck round bottom flask was charged with a solution containing 1.5 g ethylenediamine in 50 g butylacetate. A solution containing 2.78 g of isophorone diisocyanate in 80 g of butylacetate was slowly added with vigorous stirring. The mixture showed white solid formation immediately after the addition of the diisocyanate. A solution containing 100 g of Fluid B in 54.4 g of butylacetate was further added to the mixture with stirring. Another solution containing 7.88 g of isophorone diisocyanate in 40 g of butylacetate was slowly added to the mixture with vigorous stirring. The mixture gelled half way during the addition of the diisocyanate solution. This is a clear indication of premature crosslinking. The resulting gel could not be redissolved upon heating to 120° C.

### Example A6

(A) In a 100 mL round bottom flask was charged with a solution of 4.44 g isophorone diisocyanate in 20 g butylacetate. Ethylene glycol (0.62 g) was then added. It was observed that ethylene glycol was insoluble in butylacetate solution. One drop (0.02 g) of dibutyltindilaurate was then added to the mixture with stirring. Within five minutes, the mixture became homogeneous.

(B) Separately, in a 300 mL 3-neck round bottom flask was charged with a solution of 40 g Fluid A in 80 g butylacetate. The solution prepared in (A) was then slowly dropped in with stirring over 5 minutes. The addition caused an exothermic reaction that raised the temperature of the mixture from 21° C. to 26° C. with visible thickening of the mixture.

A film was cast from this mixture via solvent evaporation. The film was tack free in 5 hours and was cured. The film could not be redissolved by butylacetate.

### Example A7

A mixture containing 200 g Fluid A and 5.81 g N,N′-Diethylethylenediamine was placed in a 500 mL 3-neck round bottom flask and heated to 80° C. with stirring. 1,3-Bis(cyanatomethyl)cyclohexane (15.52 g) was then slowly dropped in. The resulting mixture turned cloudy immediately upon addition of the diisocyanate. Mixture became very viscous and difficult to stir when 13.44 g diisocyanate was added. The reaction was then stopped and the reaction mixture was transferred into a glass jar and tightly capped. The mixture was then observed to be a milky hot melt that flowed upon heating and solidified upon cooling.

A piece of elastomer was prepared by pouring the hot melt into a Teflon mold. Overnight, the elastomer was cured and would not flow upon further heating whereas the hot melt in the glass jar remained flowable upon heating.

The white milky elastomer was placed in a 150° C. oven and aged for a month. The elastomer turned brownish but remained elastomeric after one month.

### Example A8

In a 300 mL 3-neck round bottom flask was charged with 19.4 g 1,3-bis(cyanatomethyl)cyclohexane and 3.8 g 1,3-propanediol. The hazy mixture was heated to 85° C. with stirring. One drop of dibutyltindilaurate was then added and the mixture turned clear immediately. The mixture turned very viscous in 10 minutes. To this mixture was further added a pre-heated 200 g Fluid A at 85° C. with rapid stirring. The mixture turned very viscous upon addition of Fluid A but remained flowable when further heated to 100° C. The product is a translucent hot melt which moisture cured.

### Example A9

In a 500 mL 3-neck round bottom flask was placed 200 g Fluid A and heated to 85° C. with stirring. 1,3-Bis(cyanatomethyl)cyclohexane (9.4 g) was dropped in over 5 minutes with stirring. The mixture turned increasingly viscous with addition of diisocyanate. The mixture was transferred into a glass jar with the aid of a heating gun and was then tightly capped. A test sheet was prepared by pouring the mixture hot into a Teflon mold. The clear test sheet was allowed to stand in ambient conditions and was found to be tack free overnight. The cured sheet was placed in a 150° C. oven and aged for 1 month. The test sheet turned brownish but remained clear and elastomeric. In contrast, the mixture in the glass jar remained flowable upon heating.

### Example A10

In a 500 mL 3-neck round bottom flask was placed 200 g of Fluid A and heated with stirring to a temperature of 130° C. Isophorone diisocyanate (11.1 g) was added dropwise with stirring over a 5 minute period of time. The mixture turned increasingly viscous with addition of diisocyanate. The reaction was stopped when 90% of the diisocyanate was added and the mixture became too viscous to stir. The content was transferred into a glass jar with the aid of a heating gun and was then tightly capped. A test sheet was prepared by pouring the mixture hot into a Teflon mold. The clear test sheet was allowed to stand in ambient conditions and was found to be tack free overnight. The cured sheet was placed in a 150° C. oven and aged for 1 month. The test sheet turned brownish but remained clear and elastomeric. In contrast, the mixture in the glass jar remained flowable upon heating. A viscosity vs. temperature determination showed that the viscosity of this material at 40° C. was 70,000 cps but <10,000 cps at 80° C.

### Example A11

Example 9 was repeated but at 135-140° C. Complete addition of 11.1 g isophorone diisocyanate was accomplished. The content showed a viscosity of >700,000 cps at 40° C. but <200,000 cps at 80° C.

### Example A12

In a 500 mL 3-neck round bottom flask was placed 200 g Fluid A and heated to 115-120° C. with stirring. Hexamethylene diisocyanate (8.4 g) was dropped in over 5 minutes with stirring. The mixture turned increasingly viscous with addition of diisocyanate. The reaction was stopped when 7.1 g of the diisocyanate was added and the mixture became too viscous to stir. The content was transferred into a glass jar and was then tightly capped. The mixture remained flowable at room temperature. The viscosity vs. temperature relationship was determined first by heating the sample from room temperature to 170° C. followed by cooling the sample back to 40° C. at the rate of 2° C./min during both heating and cooling. The results shown on FIG. 1 indicated substantially higher viscosity during cooling due to moisture cure during the test.

### Example A13

### Comparison Example Showing Premature Crosslinking Using Primary Functional Amino Fluid

In a 500 mL 3-neck round bottom flask was charged with 200 g Fluid B and heated to 110° C. with stirring. 1,3-Bis(cyanatomethyl)cyclohexane (9.7 g) was slowly dropped in. However, the mixture gelled when only 2.0 g of the diisocyanate was added. The gelled mixture did not flow upon further heating due to extensive biuret crosslinking.

### Example A14

Thermogravimetrical analysis was performed using samples from Examples 7 and 8. As a comparison Wacker TPSE80 which is a thermoplastic silicone with no moisture cure capability was also tested. The results are shown on FIG. 2. Both samples from the instant invention were shown to have lower weight loss during heating than Wacker TPSE80.

### Compositions of Formula B

### Example B1

A reaction kettle was charged with 510.77 g of an α,ω-ethylaminoisobutyldimethoxysilyl terminated polydimethylsiloxane containing 233 mmoles of amine and cyclohexylaminomethyltrimethoxysilane (54.29 g; 223 mmol amine). With vigorous mixing, 25.86 g of isophorone diisocyanate (233 mmoles with 466 molar eq. isocyanate) was slowly added dropwise. The addition caused a mild exothermic reaction that raised the temperature of the mixture from 21° C. to 34° C. The resulting mixture was a hazy and viscous liquid.

As a comparison, when cyclohexylaminomethyltrimethoxysilane was not used in the above preparation, the mixture turned into a solid which would not melt, even upon heating to 150° C. when less than half of the isophorone diisocyanate was added.

### Example B2

A reaction kettle was charged with 315.30 g of an α,ω-aminopropyldimethoxysilyl terminated polydimethylsiloxane containing 52.3 mmoles of amine and 3.82 g of butylamine (52.3 mmoles). With vigorous stirring, 7.68 g of isophorone diisocyanate (34.6 mmoles with 69.2 molar eq. of isocyanate) was added to the mixture. The mixture turned hazy and extremely viscous and was difficult to mix. The mixture was further heated to 100° C. Another 9.34 g portion of isophorone diisocyanate (17.7 mmoles) was then added. The mixture immediately turned into a white solid. The mixture was then further heated to 160° C. when the white solid melted. The mixture was a white solid upon cooling to room temperature.

As a comparison, when butylamine was not used in the above preparation, the mixture turned into a solid that would not melt even at 160° C. when less than half of the isophorone diisocyanate was added.

### Example B3

A reaction kettle was charged with 305.69 g of an α,ω-aminopropyldimethoxysilyl terminated polydimethylsiloxane containing 50.7 mmoles of amine. The fluid was heated to 90° C. with stirring. A mixture containing 1.27 g of cyclohexylisocyanate (10.2 molar eq.) and 4.51 g of isophorone diisocyanate (40.6 molar eq. of isocyanate) was placed in an addition funnel and slowly dropped into the heated fluid over a period of 5 minutes. The reaction mixture turned very viscous but was still a flowable liquid. The mixture was vacuum stripped at 125° C. for de-aeration. The mixture turned into a clear solid upon cooling to room temperature.

### Example B4

Example 3 was repeated with 314.59 g of the α,ω-aminopropyldimethoxysilyl terminated polydimethylsiloxane containing 52.2 mmoles of amine and 2.90 g of isophorone diisocyanate (26.1 molar eq. isocyanate) and 3.26 g cyclohexylisocyanate (26.1 molar eq.). The resulting polymer is a viscous liquid at room temperature.

### Compositions of Formula C

### Example C1

A 1-liter reaction kettle was charged with a solution containing 2.47 g 2-isocyanatoethylmethacrylate, 1.76 g isophorone diisocyanate in 34 g ethyl acetate. A solution containing 200 g of an α,ω-aminopropyldimethoxysilyl terminated polydimethylsiloxane (31.78 mmole NH₂) in 34 g ethyl acetate was then slowly dripped into the polydimethylsiloxane solution with vigorous mixing. To this mixture was further sequentially added the following: 2.0 g of diethoxyacetophenone; 2.04 g of phenyltrimethoxysilane; a polymerization inhibitor, MEHQ 0.4 g; and 0.20 g of Formrez UL-38 (a tin catalyst from GE) with vigorous mixing.

The mixture was further divided into 2 approximately equal fractions in approximately 2:1 ratio. The first fraction with ⅔ of the total weight was cast into two 75 mil films and UV cured using medium pressure mercury lamp at an intensity of 70 mw/cm² for 60 seconds on each side. One film was subjected to testing immediately following UV cure and was found to shown a tensile strength of 70 psi with 240% elongation. The second film was further allowed to undergo moisture cure under ambient conditions for 7 days. Testing of this film indicated a tensile of 90 psi with 90% elongation. Compared with the first film, the second film showed a further tightening of the crosslinked network resulted in the higher tensile but lower elongation due to a second mode of moisture cure.

The second fraction of the reaction mixture with ⅓ of the total weight was also cast into 75 mil film. The film was allowed to undergo moisture cure only without UV for 7 days. The mixture cured to a solid film with 50 psi tensile and 110% elongation.

What is claimed is:

1. A curable hot melt composition comprising a reactive polymer having the Formula A(II): 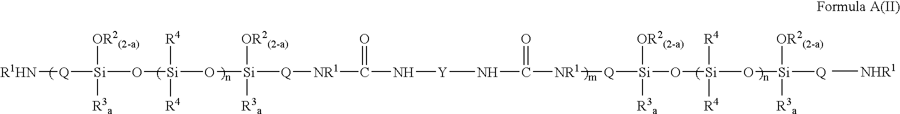
wherein
R¹ in each occurrence may be the same or different and is selected from the group consisting of H and a C₁ to C₁₀ hydrocarbon radical;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical;
Q in each occurrence may be the same or different and is a C, to C₁₀ hydrocarbon diradical;
Y in each occurrence may be the same or different and is a C₁ to C₂₀ hydrocarbon diradical;
n in each occurrence may be the same or different and is 1 to about 1,200;
m is 1 to about 100; and
a in each occurrence may be the same or different and is 0 or 1.

3. (canceled)

4. The composition of claim 1, wherein the average molecular weight of siloxane I is about 5,000 atomic mass units to about 15,000 atomic mass units.

6-9. (canceled)

10. A process for making a moisture curable composition comprising the steps of:
a. providing a mixture of:
i) a first reactant comprising a diisocyanate; and
ii) a second reactant comprising an aminoalkylenealkoxy terminated polyalkylsiloxane; and
b. reacting the first and second reactants to form the moisture curable composition.

11. A method of improving the high-temperature physical properties of the curable hot melt composition of claim 1 comprising the steps of:
a. providing the curable hot melt composition of claim 1; and
b. exposing the hot melt composition to curing conditions,
whereby the polymer chain segments capable of hydrogen bonding are held in sufficient proximity to each other to permit hydrogen bonding.

12. A method of using the curable hot melt composition of claim 1 comprising the steps of:
a. providing a sealed container of the curable hot melt composition; 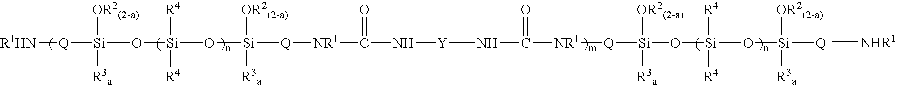
b. heating the hot melt composition to a temperature sufficient to permit dispensing of the adhesive; and
c. dispensing the hot melt composition onto a substrate and permitting the adhesive to cure.

13. The hot melt composition of claim 1 further comprising,
a moisture resistant container capable of housing and/or dispensing the hot melt composition b.

14. A composition comprising a polymer of Formula B(I): 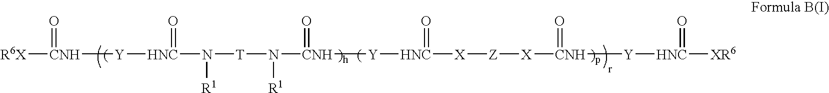
wherein
R¹ in each occurrence may be the same or different and is a member selected from the group consisting of H and a C₁ to C₁₀ hydrocarbon radical;
R⁶ in each occurrence may be the same or different and is a member selected from the group consisting of H and a C₁ to C₁₀ hydrocarbon radical;
T in each occurrence may be the same or different and is: 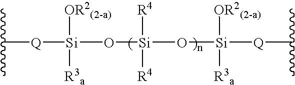
wherein
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical;
Q in each occurrence may be the same or different and is a C₁ to C₁₀ hydrocarbon diradical;
n in each occurrence may be the same or different and is 1 to about 1,200; and
a in each occurrence may be the same or different and is 0 or 1;
Y in each occurrence may be the same or different and is a C₁ to C₂₀ hydrocarbon diradical;
Z in each occurrence may be the same or different and is a C₁ to C₂₀ hydrocarbon diradical;
X in each occurrence may be the same or different and is a member selected from the group consisting of O, S, and NR⁵,
wherein R⁵ in each occurrence may be the same or different and is a member selected from the group consisting of H, a C₁ to C₁₀ hydrocarbon radical, and (R⁷O)_{b}SiR⁸_{(3-b)}-Q-,
wherein
R⁷ in each occurrence may be the same or different and is C₁ to C₁₀ alkyl;
R⁸ in each occurrence may be the same or different and is C₁ to C₁₀ alkyl; and
b in each occurrence may be the same or different and is 0, 1, or 2;
h is 1 to about 100;
p is 0 to about 100; and
r is 1 to about 100.

15. A composition comprising a polymer of Formula B(II): 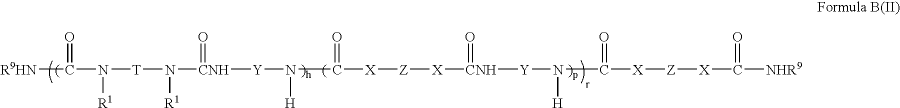
wherein
R¹ in each occurrence may be the same or different and is a member selected from the group consisting of H and C₁ to C₁₀ alkyl;
R⁹ in each occurrence may be the same or different and is a C₁ to COO hydrocarbon radical;
T in each occurrence may be the same or different and is: 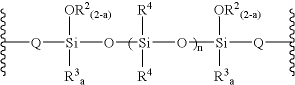
wherein
R² in each occurrence may be the same or different and is C₁ to C₁₀ hydrocarbon radical;
R³ in each occurrence may be the same or different and is a C₁ to C₁₀ hydrocarbon radical
R⁴ in each occurrence may be the same or different and is a C₁ to C₁₀ hydrocarbon radical;
Q in each occurrence may be the same or different and is a C₁ to C₁₀ hydrocarbon diradical;
n in each occurrence may be the same or different and is 1 to about 1,200; and
a in each occurrence may be the same or different and is 0 or 1;
Y in each occurrence may be the same or different and is a C₁ to C₂₀ hydrocarbon diradical;
Z in each occurrence may be the same or different and is a C₁ to C₂₀ hydrocarbon diradical;
X in each occurrence may be the same or different and is a member selected from the group consisting of O, S, and NR⁵,
wherein R⁵ in each occurrence may be the same or different and is a member selected from the group consisting of H, a C₁ to C₁₀ hydrocarbon radical, and (R⁷O)_{b}SiR⁸_{(3-b)}-Q-,
wherein
R⁷ in each occurrence may be the same or different and is C₁ to C₁₀ alkyl;
R⁸ in each occurrence may be the same or different and is C₁ to C₁₀ alkyl;
b in each occurrence may be the same or different and is 0, 1, or 2;
h is 1 to about 100;
p is 0 to about 100; and
r is 1 to about 100.

16. A composition comprising a polymer of Formula B(III): 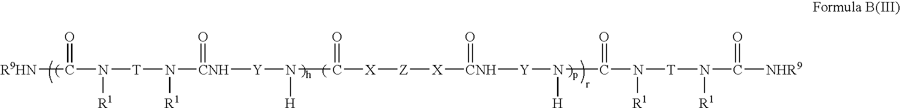
wherein
R¹ in each occurrence may be the same or different and is a member selected from the group consisting of H and C₁ to C₁₀ alkyl;
R⁹ in each occurrence may be the same or different and is a C₁ to C₁₀ hydrocarbon radical;
T in each occurrence may be the same or different and is: 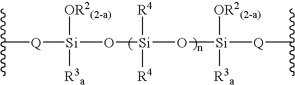
wherein
R² in each occurrence may be the same or different and is a C₁ to C₁₀ hydrocarbon radical;
R³ in each occurrence may be the same or different and is a C₁ to C₁₀ hydrocarbon radical
R⁴ in each occurrence may be the same or different and is a C₁ to C₁₀ hydrocarbon radical;
Q in each occurrence may be the same or different and is a C₁ to C₁₀ hydrocarbon diradical;
n in each occurrence may be the same or different and is 1 to about 1,200; and
a in each occurrence may be the same or different and is 0 or 1;
Y in each occurrence may be the same or different and is a C₁ to C₂₀ hydrocarbon diradical;
Z in each occurrence may be the same or different and is a C₁ to C₂₀ hydrocarbon diradical;
X in each occurrence may be the same or different and is a member selected from the group consisting of O, S, and NR⁵,
wherein R⁵ in each occurrence may be the same or different and is a member selected from the group consisting of H, a C, to C₁₀ hydrocarbon radical, and (R⁷O)_{b}SiR⁸_{(3-b)}-Q-,
wherein
R⁷ in each occurrence may be the same or different and is C₁ to C₁₀ alkyl;
R⁸ in each occurrence may be the same or different and is C₁ to C₁₀ alkyl;
b in each occurrence may be the same or different and is 0, 1, or 2;
h is 1 to about 100;
p is 0 to about 100; and
r is 1 to about 100.

17. A composition comprising a polymer of Formula B(IV): 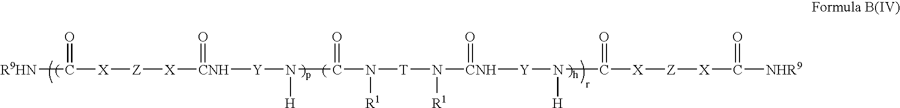
wherein
R¹ in each occurrence may be the same or different and is a member selected from the group consisting of H and C₁ to C₁₀ alkyl;
R⁹ in each occurrence may be the same or different and is a C, to C₁₀ hydrocarbon radical;
T in each occurrence may be the same or different and is: 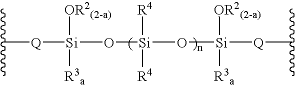
wherein
R² in each occurrence may be the same or different and is a C₁ to C₁₀ hydrocarbon radical;
R³ in each occurrence may be the same or different and is a C₁ to C₁₀ hydrocarbon radical
R⁴ in each occurrence may be the same or different and is a C₁ to C₁₀ hydrocarbon radical;
Q in each occurrence may be the same or different and is a C₁ to C₁₀ hydrocarbon diradical;
n in each occurrence may be the same or different and is 1 to about 1,200; and
a in each occurrence may be the same or different and is 0 or 1;
Y in each occurrence may be the same or different and is a C₁ to C₂₀ hydrocarbon diradical;
Z in each occurrence may be the same or different and is a C₁ to C₂₀ hydrocarbon diradical;
X in each occurrence may be the same or different and is a member selected from the group consisting of O, S, and NR⁵,
wherein R⁵ in each occurrence may be the same or different and is a member selected from the group consisting of H, a C₁ to C₁₀ hydrocarbon radical, and (R⁷O)_{b}SiR⁸_{(3-b)}-Q-,
wherein
R⁷ in each occurrence may be the same or different and is C₁ to C₁₀ alkyl;
R⁸ in each occurrence may be the same or different and is C₁ to C₁₀ alkyl;
b in each occurrence may be the same or different and is 0, 1, or 2;
h is 1 to about 100;
p is 0 to about 100; and
r is 1 to about 100.

18. A composition comprising the reaction product of:
a) a composition of the formula: 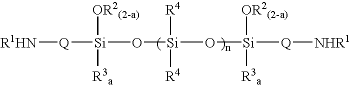
wherein
R¹ in each occurrence may be the same or different and is a member selected from the group consisting of H and C, to C₁₀ alkyl;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical;
Q is a C₁ to C₁₀ hydrocarbon diradical;
n is 1 to about 1,200; and
a in each occurrence may be the same or different and is 0 or 1;
b) a compound having the formula:
OCN—Y—NCO
wherein Y in each occurrence may be the same or different and is a C₁ to C₂₀ hydrocarbon diradical;
c) a compound having the formula:
HX-Z-XH
wherein
Z in each occurrence may be the same or different and is a C₁ to C₂₀ hydrocarbon diradical;
X in each occurrence may be the same or different and is a member selected from the group consisting of O, S, and NR⁵,
wherein R⁵ in each occurrence may be the same or different and is a member selected from the group consisting of H, a C₁ to C₁₀ hydrocarbon radical, and (R⁷O)_{b}SiR⁸_{(3-b)}-Q-
wherein
R⁷ in each occurrence may be the same or different and is C₁ to C₁₀ alkyl;
R⁸ in each occurrence may be the same or different and is C₁ to C₁₀ alkyl;
Q is a C₁ to C₁₀ hydrocarbon diradical;
n is 1 to about 1,200; and
a in each occurrence may be the same or different and is 0 or 1; and
d) a compound having the formula;
R⁶—X—H
wherein
R⁶ in each occurrence may be the same or different and is a member selected from the group consisting of H and a C₁ to C₁₀ hydrocarbon radical; and
X in each occurrence may be the same or different and is a member selected from the group consisting of O, S, and NR⁵,
wherein R⁵ in each occurrence may be the same or different and is a member selected from the group consisting of H, a C₁ to C₁₀ hydrocarbon radical, and (R⁷O)_{b}SiR⁸_{(3-b)}-Q-
wherein
R⁷ in each occurrence may be the same or different and is C₁ to C₁₀ alkyl;
R⁸ in each occurrence may be the same or different and is C₁ to C₁₀ alkyl;
Q is a C₁ to C₁₀ hydrocarbon diradical;
n is 1 to about 1,200; and
a in each occurrence may be the same or different and is 0 or 1.

19. A composition comprising the reaction product of:
a) a composition of the formula: 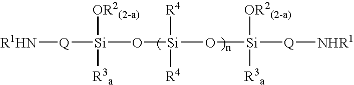
wherein
R¹ in each occurrence may be the same or different and is a member selected from the group consisting of H and C₁ to C₁₀ alkyl;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical;
Q is a C₁ to C₁₀ hydrocarbon diradical;
n is 1 to about 1,200; and
a in each occurrence may be the same or different and is 0 or 1;
b) a compound having the formula:
OCN—Y—NCO
wherein Y in each occurrence may be the same or different and is a C₁ to C₂₀ hydrocarbon diradical;
c) a compound having the formula:
HX-Z-XH
wherein
Z in each occurrence may be the same or different and is a C₁ to C₂₀ hydrocarbon diradical;
X in each occurrence may be the same or different and is a member selected from the group consisting of O, S, and NR⁵,
wherein R⁵ in each occurrence may be the same or different and is a member selected from the group consisting of H, a C₁ to C₁₀ hydrocarbon radical, and (R⁷O)_{b}SiR⁸_{(3-b)}-Q-
wherein
R⁷ in each occurrence may be the same or different and is C₁ to C₁₀ alkyl;
R⁸ in each occurrence may be the same or different and is C₁ to C₁₀ alkyl;
Q is a C₁ to C₁₀ hydrocarbon diradical;
n is 1 to about 1,200; and
a in each occurrence may be the same or different and is 0 or 1; and
d) a compound having the formula;
R⁹—NCO
wherein R⁹ in each occurrence may be the same or different and is a C₁ to C₁₀ hydrocarbon radical.

20. A method for making a composition comprising reacting:
a) a composition of the formula: 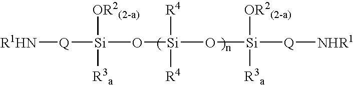
wherein
R¹ in each occurrence may be the same or different and is a member selected from the group consisting of H and C₁ to C₁₀ alkyl;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical;
Q is a C₁ to C₁₀ hydrocarbon diradical;
n is 1 to about 1,200; and
a in each occurrence may be the same or different and is 0 or 1;
b) a compound having the formula:
OCN—Y—NCO
wherein Y in each occurrence may be the same or different and is a C₁ to C₂₀ hydrocarbon diradical;
c) a compound having the formula:
HX-Z-XH
wherein
Z in each occurrence may be the same or different and is a C₁ to C₂₀ hydrocarbon diradical;
X in each occurrence may be the same or different and is a member selected from the group consisting of O, S, and NR⁵,
wherein R⁵ in each occurrence may be the same or different and is a member selected from the group consisting of H, a C₁ to C₁₀ hydrocarbon radical, and (R⁷O)_{b}SiR⁸_{(3-b)}-Q-
wherein
R⁷ in each occurrence may be the same or different and is C₁ to C₁₀ alkyl;
R⁸ in each occurrence may be the same or different and is C₁ to C₁₀ alkyl;
Q is a C₁ to C₁₀ hydrocarbon diradical;
n is 1 to about 1,200; and
a in each occurrence may be the same or different and is 0 or 1; and
d) a compound having the formula;
R⁶—X—H
wherein
R⁶ in each occurrence may be the same or different and is a member selected from the group consisting of H and a C₁ to C₁₀ hydrocarbon radical; and
X in each occurrence may be the same or different and is a member selected from the group consisting of O, S, and NR⁵,
wherein R⁵ in each occurrence may be the same or different and is a member selected from the group consisting of H, a C₁ to C₁₀ hydrocarbon radical, and (R⁷O)_{b}SiR⁸_{(3-b)}-Q-
wherein
R⁷ in each occurrence may be the same or different and is C₁ to C₁₀ alkyl;
R⁸ in each occurrence may be the same or different and is C₁ to C₁₀ alkyl;
Q is a C₁ to C₁₀ hydrocarbon diradical;
n is 1 to about 1,200; and
a in each occurrence may be the same or different and is 0 or 1.

21. A method for making a composition comprising reacting:
a) a composition of the formula: 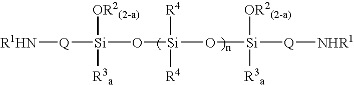
wherein
R¹ in each occurrence may be the same or different and is a member selected from the group consisting of H and C₁ to C₁₀ alkyl;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical;
Q is a C₁ to C₁₀ hydrocarbon diradical;
n is 1 to about 1,200; and
a in each occurrence may be the same or different and is 0 or 1;
b) a compound having the formula:
OCN—Y—NCO
wherein Y in each occurrence may be the same or different and is a C₁ to C₂₀ hydrocarbon diradical;
c) a compound having the formula:
HX-Z-XH
wherein
Z in each occurrence may be the same or different and is a C₁ to C₂₀ hydrocarbon diradical;
X in each occurrence may be the same or different and is a member selected from the group consisting of O, S, and NR⁵,
wherein R⁵ in each occurrence may be the same or different and is a member selected from the group consisting of H, a C₁ to C₁₀ hydrocarbon radical, and (R⁷O)_{b}SiR⁸_{(3-b)}-Q-
wherein
R⁷ in each occurrence may be the same or different and is C₁ to C₁₀ alkyl;
R⁸ in each occurrence may be the same or different and is C₁ to C₁₀ alkyl;
Q is a C₁ to C₁₀ hydrocarbon diradical;
n is 1 to about 1,200; and
a in each occurrence may be the same or different and is 0 or 1; and
d) a compound having the formula;
R⁹—NCO
wherein R⁹ in each occurrence may be the same or different and is a C₁ to C₁₀ hydrocarbon radical.

22. A method of using the composition of claim 14 comprising the steps of:
a) providing a sealed container of the composition of claim 14 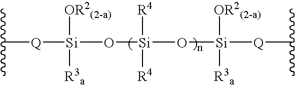
b) exposing the composition of Formula (I) to a temperature sufficient to permit the composition to be flowable; and
c) applying the composition of Formula (I) onto a substrate and permitting the composition to cure.

23. A method of using the composition of claim 15 comprising the steps of:
a) providing a sealed container of the composition of claim 15 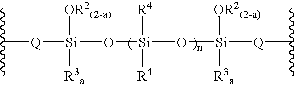
b) exposing the composition of step a) to a temperature sufficient to permit the composition to be flowable; and
c) applying the composition of step b) onto a substrate and permitting the composition to cure.

24. A composition comprising a polymer of Formula C(I): 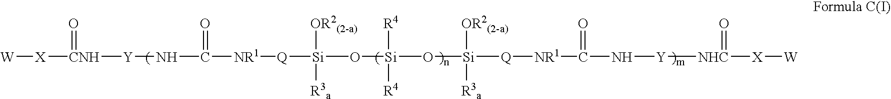
wherein
R¹ in each occurrence may be the same or different and is a member selected from the group consisting of H and a C₁ to C₁₀ hydrocarbon radical;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical;
X in each occurrence can be the same or different and is a member selected from the group consisting of O, S, and NR¹⁰,
wherein R¹⁰ in each occurrence may be the same or different and is a member selected from the group consisting of H and a C₁ to C₁₀ hydrocarbon radical;
Y in each occurrence may be the same or different and is a C₁ to C₂₀ hydrocarbon diradical;
W in each occurrence may be the same or different and is C₂ to C₁₀ hydrocarbon radical capable of free-radical polymerization containing at least one of: a double bond, a carbonyl group, or an epoxide group;
Q in each occurrence may be the same or different and is a C₁ to C₁₀ hydrocarbon diradical;
n in each occurrence may be the same or different and is 1 to about 1,200;
m is 1 to about 100; and
a in each occurrence may be the same or different and is 0 or 1.

25. A composition comprising a polymer of Formula C(III): 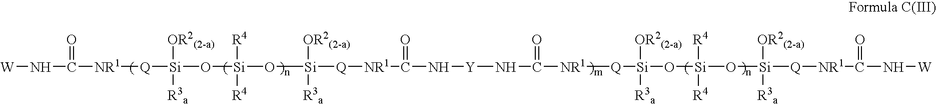
wherein
Y in each occurrence may be the same or different and is a C₁ to C₂₀ hydrocarbon diradical;
W in each occurrence may be the same or different and is a C₂ to C₁₀ hydrocarbon radical capable of free-radical polymerization containing at least one of: a double bond, a carbonyl group, or an epoxide group;
Q in each occurrence may be the same or different and is a C, to C₁₀ hydrocarbon diradical;
R¹ in each occurrence may be the same or different and is a member selected from the group consisting of H and a C₁ to C₁₀ hydrocarbon radical;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a member selected from the group consisting of H and a C₁ to C₁₀ hydrocarbon radical;
n in each occurrence may be the same or different and is 1 to about 1,200;
m is 1 to about 100; and
a in each occurrence may be the same or different and is 0 or 1.

26. A composition comprising the reaction product of:
a) a composition of Formula C(IV): 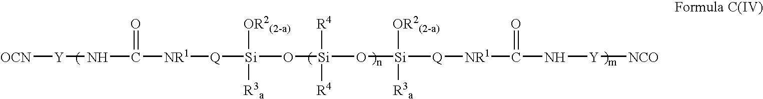
wherein
Y in each occurrence may be the same or different and is a C₁ to C₂₀ hydrocarbon diradical;
Q in each occurrence may be the same or different and is a C, to C₁₀ hydrocarbon diradical;
R¹ in each occurrence may be the same or different and is a member selected from the group consisting of H and a C₁ to C₁₀ hydrocarbon radical;
R² in each occurrence may be the same or different and is a C₁ to C₁₀ hydrocarbon radical;
R³ in each occurrence may be the same or different and is C₁ to C₁₀ hydrocarbon radical;
R⁴ in each occurrence may be the same or different and is a C₁ to C₁₀ hydrocarbon radical;
n in each occurrence may be the same or different and is 1 to about 1,200;
m is 1 to about 100; and
a in each occurrence may be the same or different and is 0 or 1; and
b) a compound having the structure:
W—X—H
wherein
X in each occurrence may be the same or different and is a member selected from the group consisting of O, S, and NR¹⁰,
wherein R¹⁰ in each occurrence may be the same or different and is a member selected from the group consisting of H and a C₁ to C₁₀ hydrocarbon radical;
W in each occurrence may be the same or different and is C₂ to C₁₀ hydrocarbon radical capable of free-radical polymerization containing at least one of: a double bond, a carbonyl group, or an epoxide group.

27. A composition comprising the reaction product of:
a) a composition having the formula: 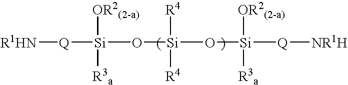
wherein
Q in each occurrence may be the same or different and is a C₁ to C₁₀ hydrocarbon diradical;
R¹ in each occurrence may be the same or different and is a member selected from the group consisting of H and a C, to C₁₀ hydrocarbon radical;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical; and
n in each occurrence may be the same or different and is 1 to about 1,200;
b) a compound having the structure:
OCN—Y—NCO
wherein Y is a C₁ to C₂₀ hydrocarbon diradical; and
c) a compound having the formula:
W—NCO
wherein W is a C₂ to C₁₀ hydrocarbon radical capable of free-radical polymerization containing at least one of: a double bond, a carbonyl group, or an epoxide group.

28. A composition comprising the reaction product of:
a) a composition of Formula C(V): 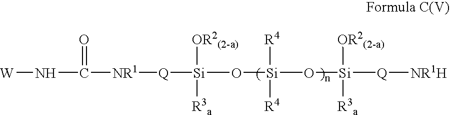
wherein
W is a C₂ to C₁₀ hydrocarbon radical capable of free-radical polymerization containing at least one of: a double bond, a carbonyl group, or an epoxide group
Q in each occurrence may be the same or different and is a C₁ to C₁₀ hydrocarbon diradical;
R¹ in each occurrence may be the same or different and is a member selected from the group consisting of H and a C₁ to C₁₀ hydrocarbon radical;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical; and
n in each occurrence may be the same or different and is 1 to about 1,200; and
b) a compound having the structure:
OCN—Y—NCO
wherein Y is a C₁ to C₂₀ hydrocarbon diradical.

29. A method for making a composition comprising the steps of:
a) reacting:
i) a compound having the formula: 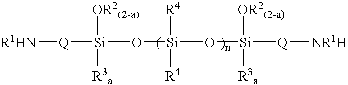
wherein
Q in each occurrence may be the same or different and is a C₁ to C₁₀ hydrocarbon diradical;
R¹ in each occurrence may be the same or different and is a member selected from the group consisting of H and a C₁ to C₁₀ hydrocarbon radical;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical; and
n in each occurrence may be the same or different and is 1 to about 1,200; with
ii) a compound having the formula
OCN—Y—NCO
wherein Y is a C₁ to C₂₀ hydrocarbon diradical; and
b) reacting the reaction product of step a) with a compound having the structure:
W—X—H
wherein
X in each occurrence may be the same or different and is a member selected from the group consisting of O, S, and NR¹⁰,
wherein R¹⁰ in each occurrence may be the same or different and is a member selected from the group consisting of H and a C₁ to C₁₀ hydrocarbon radical; and
W in each occurrence may be the same or different and is a C₂ to C₁₀ hydrocarbon radical capable of free-radical polymerization containing at least one of: a double bond, a carbonyl group, or an epoxide group.

30. A method for making a composition comprising the steps of reacting:
a) a compound having the formula: 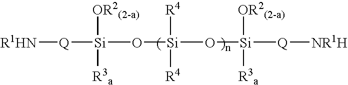
wherein
Q in each occurrence may be the same or different and is a C₁ to C₁₀ hydrocarbon diradical;
R¹ in each occurrence may be the same or different and is a member selected from the group consisting of H and a C₁ to a C₁₀ hydrocarbon radical;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical; and
n in each occurrence may be the same or different and is 1 to about 1,200;
b) a compound having the structure
W—NCO
wherein W is a C₂ to C₁₀ hydrocarbon radical capable of free-radical polymerization containing at least one of: a double bond, a carbonyl group, or an epoxide group; and
c) a compound having the structure:
OCN—Y—NCO
wherein Y is a C₁ to C₂₀ hydrocarbon diradical.

31. A method of using the composition of claim 24 comprising the steps of:
a) providing a sealed container of the composition of claim 24
b) heating the polymer of Formula (I) to a temperature sufficient to permit dispensing of the polymer; and
c) dispensing the polymer of Formula (I) onto a substrate and permitting the polymer to cure.

32. A method of using the composition of claim 25 comprising the steps of:
a) providing a sealed container of the composition of claim 25
b) heating polymer of Formula (I) to a temperature sufficient to permit dispensing of the polymer; and
c) dispensing the polymer of Formula (I) onto a substrate and permitting the polymer to cure.

33. A composition comprising a polymer of the Formula C(V): 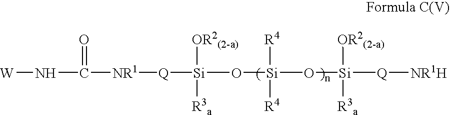
wherein
W is a C₂ to C₁₀ hydrocarbon radical capable of free-radical polymerization containing at least one of: a double bond, a carbonyl group, or an epoxide group
Q in each occurrence may be the same or different and is a C₁ to C₁₀ hydrocarbon diradical;
R¹ in each occurrence may be the same or different and is a member selected from the group consisting of H and a C₁ to C₁₀ hydrocarbon radical;
R² in each occurrence may be the same or different and is a C₁ to C₁₀ hydrocarbon radical;
R³ in each occurrence may be the same or different and is a C₁ to C₁₀ hydrocarbon radical;
R⁴ in each occurrence may be the same or different and is a C₁ to C₁₀ hydrocarbon radical; and
n in each occurrence may be the same or different and is 1 to about 1,200.
